(19) United States
(12) Patent Application Publication
(10) Pub. No.: US 2026/0128774 A1
(43) Pub. Date: May 7, 2026

(54) METHODS AND SYSTEMS FOR ADAPTIVE CSI QUANTIZATION

(71) Applicant: InterDigital Patent Holdings, Inc., Wilmington, DE (US)

(72) Inventors: Ahmet Serdar Tan, London (GB); Arman Shojaeifard, London (GB); Moon IL Lee, Melville, NY (US); Patrick Tooher, Montreal (CA); Yugeswar Deenoo Narayanan Thangaraj, Chalfont, PA (US); Mohamed Salah Ibrahim, Chesterbrook, PA (US); Ibrahim Hemadeh, Hemel Hempstead (GB); Mihaela Beluri, Jericho, NY (US)

(73) Assignee: InterDigital Patent Holdings, Inc., Wilmington, DE (US)

(21) Appl. No.: 19/119,013

(22) PCT Filed: Oct. 27, 2023
(86) PCT No.: PCT/US2023/078064

§ 371 Date: Apr. 7, 2025

Related U.S. Application Data
(60) Provisional application No. 63/421,865, filed on Nov. 2, 2022.

(51) Int. Cl. H04B 7/06; H04B 17/318; H04W 72/21

(52) U.S. Cl. CPC H04B 7/0626; H04B 7/0658; H04B 17/328; H04W 72/21

(57) ABSTRACT

A wireless transmit/receive unit (WTRU) is configured to receive configuration information from a network node for the alignment of one or more compressed channel state information (CSI) quantizers at the WTRU and the network node. The configuration information may indicate a plurality of CSI quantization settings and/or criteria for selecting from the plurality of CSI quantization settings. The WTRU may perform one or more CSI measurements on one or more reference signals. The WTRU may encode the one or more CSI measurements. The WTRU may select a CSI quantization setting of the plurality of quantization settings based on the criteria indicated in the configuration information. The WTRU may quantize the encoded one or more CSI measurements using the selected CSI quantization setting. The WTRU may send a feedback report comprising the quantized one or more CSI measurements and/or an indication of the selected CSI quantization setting to the network node.

### CROSS-REFERENCE TO RELATED APPLICATIONS

This application claims priority to U.S. Provisional Patent Application No. 63/421,865, filed Nov. 2, 2022, the contents of which are incorporated herein by reference in their entirety.

### BACKGROUND

Information compression methods, such as channel state information (CSI) compression, may be studied for future wireless communication systems. CSI data for multiple input multiple output (MIMO) communications to the receiving end may cause large overhead unless efficient compression techniques are used.

### SUMMARY

In examples, methods and/or procedures may be utilized to enable an adaptive quantization process for the output of encoder part of an autoencoder trained for information compression (e.g., channel state information (CSI) compression). Examples may include a configuration of the adaptive (e.g., primary) CSI quantizer, selection and/or determination of related parameters, feedback of the parameters, and/or monitoring and/or reporting of its performance to a receiving end.

A wireless transmit/receive unit (WTRU) may receive configuration information from a network node for the alignment of one or more compressed channel state information (CSI) quantizers at the WTRU and at the network node. The configuration information may indicate a plurality of CSI quantization settings and/or criteria for selecting from the plurality of CSI quantization settings. The WTRU may perform one or more CSI measurements on one or more reference signals. The WTRU may encode the one or more CSI measurements. The WTRU may select a CSI quantization setting of the plurality of quantization settings based on the criteria indicated in the configuration information. The WTRU may quantize the encoded one or more CSI measurements using the selected CSI quantization setting. The WTRU may send a feedback report comprising the quantized one or more CSI measurements and/or an indication of the selected CSI quantization setting to the network node for the alignment of the one or more compressed CSI quantizers at the WTRU and the network node.

The criteria may be based on one or more of a reference signal received power (RSRP) measurement, a CSI measurement, a type of the feedback report, resources used for sending the feedback report, and/or a metric associated with the encoded one or more CSI measurements.

The indication of the selected CSI quantization setting may comprise an index associated with the plurality of CSI quantization settings. The indication of the selected CSI quantization setting may comprise an indication of a quantization type, a quantization parameter, a quantizer granularity, and/or a resolution of the CSI quantizer. The quantization type may comprise a single-quantizer method and/or a multiple-quantizer method. The quantizer type may comprise a distribution based method, a cluster based method, or a uniform, non-uniform, or vector based quantization. The quantization parameter may comprise distribution of encoder output or the centroids of clusters.

The WTRU may be configured with a fallback (e.g., secondary) quantizer. The WTRU may select the fallback (e.g., secondary) quantizer based on second criteria. the second criteria may comprise the current state of the WTRU's current state velocity, received signal strength indicator (RSSI), or performance of one or more compressed CSI quantizers and/or fallback (e.g., secondary) quantizers measured via cosine similarity and/or quality noise.

The WTRU may determine a quantizer parameter based on indices associated with a predefined look-up table. The WTRU may determine one or more parameters of a codebook for a predefined CSI quantizer.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example of a channel state information (CSI) measurement setting.

FIG. 3 depicts an example of a codebook-based precoding with feedback information.

FIG. 4 depicts an example of a block diagram of a CSI compression framework.

FIG. 5 depicts examples of uniform and non-uniform quantizers.

FIG. 6 depicts an example diagram of vector quantization.

FIG. 7 depicts an example of CSI compression with quantization.

FIG. 8 depicts an example of distributions of the encoder output values.

FIG. 9 depicts an example of non-uniform quantization process.

FIG. 10 depicts an example for the clustering.

FIG. 11 depicts an example of the quantization process at the wireless transmit/receive unit (WTRU).

FIG. 12 depicts an example multiple-quantizer method.

FIG. 13 depicts an example de-quantizer for the distribution-based method.

### DETAILED DESCRIPTION

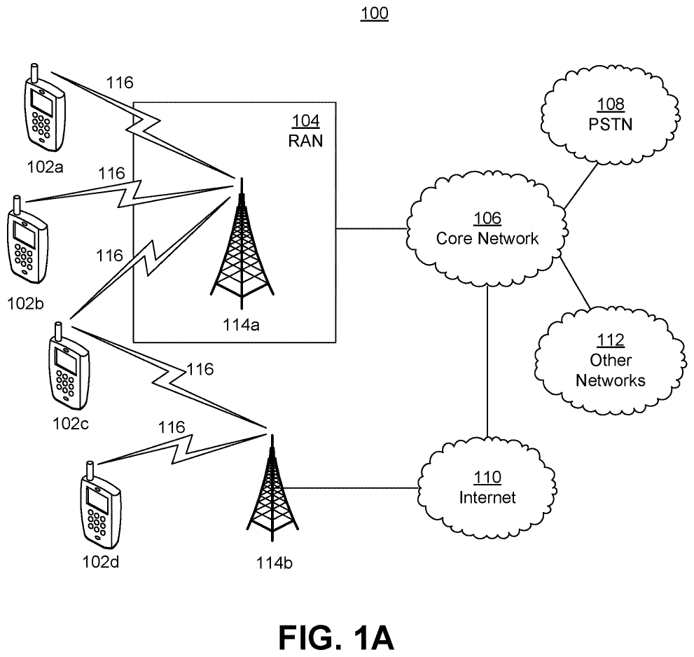

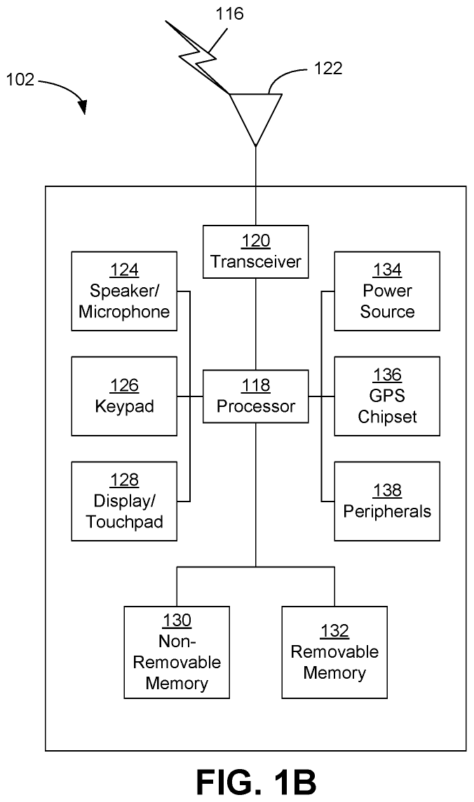

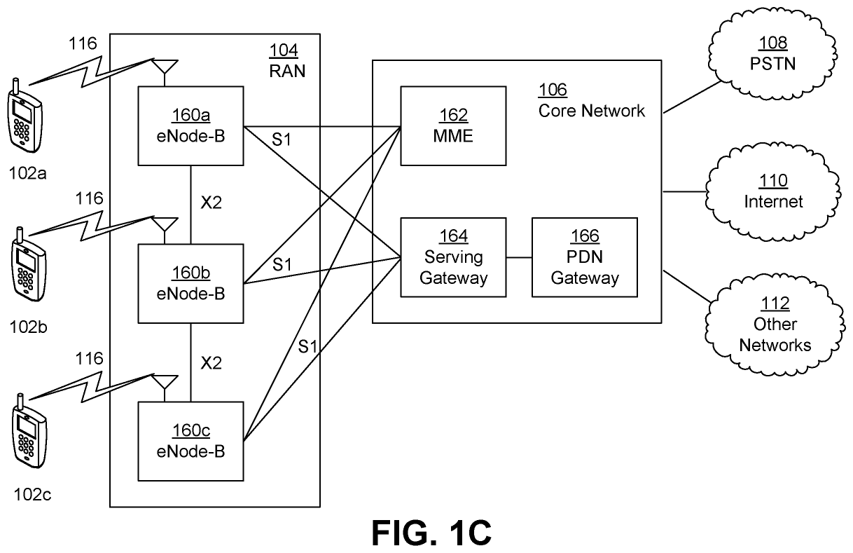

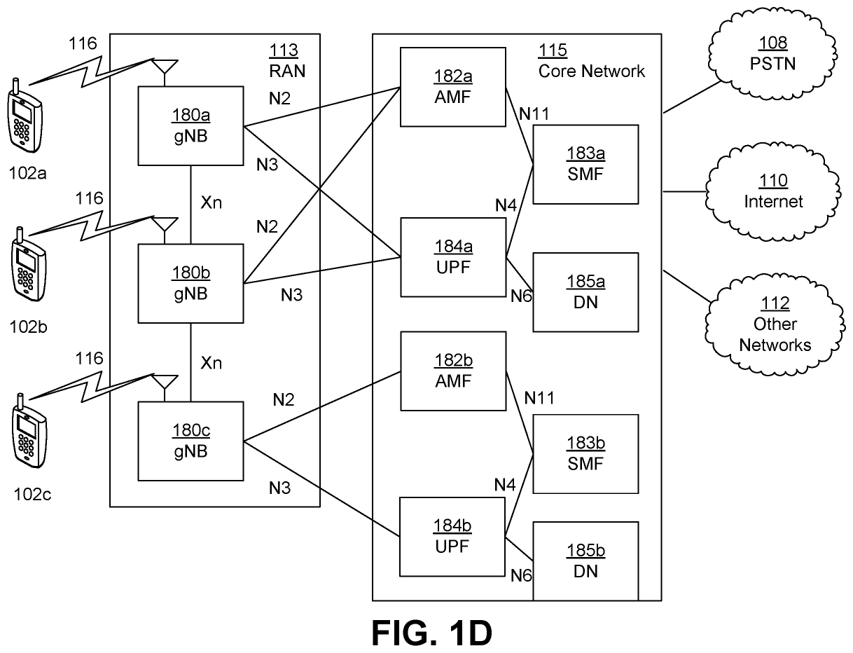

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Information compression methods, such as channel state information (CSI) compression, may be studied for future wireless communication systems. The CSI data for multiple input multiple output (MIMO) communications used in the transfer to the receiving end may cause a significant amount (e.g., large) overhead unless efficient compression techniques are used. CSI compression techniques with the scope of Rel-18 SI on artificial intelligence/machine learning (AI/ML) for Air Interface may focus on autoencoder based compression where the WTRU and/or gNB implement encoder and/or decoder section(s) of the autoencoder.

Autoencoders (AE)s are types of neural networks (e.g., deep neural networks (DNNs)) used for data compression applications. AEs may be two-sided models comprising an encoder model, which may transform the input data to a smaller dimension latent space (thus performing the compression operation), and/or a decoder model, which may perform the inverse operation and/or may reconstruct the data based on the smaller dimension latent space. For CSI compression operation(s), the encoder part of the AE may reside at the WTRU, while the decoder part of the AE may reside at the network side. The decoder part may be responsible for reconstructing (e.g., decompressing) the CSI from the received compressed CSI. The outputs of the WTRU-side encoder may be real valued and/or may include further quantization, for example, to fit in the limited feedback overhead. In examples, quantizing the output values may be uniform quantization. Other methods for quantization may include non-uniform quantization and/or vector quantization. Training the AE together with the quantizer may achieve quantization of the compressed CSI. The quantizer may be inserted independently after the training of the AE. Efficient methods for the quantization of compressed CSI may be described herein.

Training an AE with a learned quantizer may limit the flexibility of compression output and/or may require separately trained neural networks (NNs) for a given overhead. Switching between NN structures based on, for example, available feedback overhead (e.g., indicated by a base station (BS) to WTRU) may not be feasible and/or impractical.

The values of the CSI compression AE's encoder output may be more frequent on low amplitudes (e.g., non-uniformly distributed). Uniform quantizers may not be optimal for AE based CSI compression outputs. The distribution of the outputs may be different among outputs and/or may change in time. The distribution of the outputs may depend on the AE.

Vector quantization may be computation intensive. In examples, for vector quantization, the codeword may be compared to one or more (e.g., all) vectors in the codeblock. When performing vector quantization, updating the codeblock online may cause overhead.

Methods to configure adaptive (e.g., primary) quantizer are provided herein, and may include procedures for the initial configuration of the adaptive (e.g., primary) quantizer to indicate the WTRU. These procedures may include, but are not limited to, the type of method to build quantizers, number of quantizers per output, quantization performance monitoring metric and/or type of secondary quantization, etc. Procedures herein may further include procedures for the indication of the self-configuration of the adaptive (e.g., primary) quantizer.

Methods to determine the parameters of the quantizer are provided herein, and may include procedures to determine the parameters of the quantizer. Based on the initial configuration, the procedures may include, but are not limited to, characteristics of the distribution of the output values of the encoder for a distribution-based quantizer, centroids of the cluster for a cluster-based quantizer, determining parameters of quantizers for all encoder outputs at once and/or separately, and/or adapting the quantizers depending on the determined parameters.

Feedback of the quantizer parameters are provided herein, and may include procedures for WTRU feedbacks (e.g., explicitly and/or implicitly, dynamically and/or semi-statically and/or statically). The procedures may send the parameters of the quantizers and/or configurations to the gNB, for example, for approval and/or implementation of de-quantizers.

Methods for the monitoring and/or reporting of quantizer performance are provided herein, and may include procedures to monitor the quantization performance dynamically and/or quantizer performance periodically and/or dynamically based on initial configuration and/or indication from gNB, and/or reporting the performance of the quantizer and/or re-determining the parameters based on quantizer.

Methods for quantizer fallback are provided herein, and may include procedures to determine quantizer fallback including defining error threshold events, events that trigger fallback, and/or mechanisms on fallback and reporting of fallback.

CSI may include one or more of the following: channel quality index (CQI), rank indicator (RI), precoding matrix index (PMI), an L1 channel measurement (e.g., received signal received power (RSRP) such as L1-RSRP, or signal to interference and noise ratio (SINR)), CSI reference signal (CSI-RS) resource indicator (CRI), synchronization signal/physical broadcast channel (SS/PBCH) block resource indicator (SSBRI), layer indicator (LI), and/or any other measurement quantity measured by the WTRU from the configured reference signals (e.g., CSI-RS and/or SS/PBCH block and/or any other reference signal).

Criteria for selecting from the plurality of CSI quantization settings may be based on one or more of a RSRP measurement, a CSI measurement, a type of the feedback report, resources used for sending the feedback report, and/or a metric associated with the encoded one or more CSI measurements.

CSI reporting may be performed using one or more frameworks. For example, a WTRU may report the CSI through the uplink control channel on the physical uplink control channel (PUCCH), and/or per the gNB's request on an uplink (UL) physical uplink shared channel (PUSCH) grant. A CSI-RS may cover the full bandwidth or a fraction of the bandwidth of a bandwidth part (BWP), depending on the configuration.

A CSI-RS may be configured in each physical resource block (PRB) and/or every other PRB, for example, within the CSI-RS bandwidth. CSI-RS resources may be configured periodic, semi-persistent, and/or aperiodic in the time domain. Semi-persistent CSI-RS may be similar to periodic CSI-RS. However, the resource may be deactivated by medium access control control elements (MAC CEs), and/or the WTRU may report related measurements when (e.g., only when) the resource activates. For aperiodic CSI-RS, the WTRU may trigger and/or report measured CSI-RS on PUSCH (e.g., by request in a downlink control information (DCI)). Periodic reports may be carried over the PUCCH. Either PUCCH and/or PUSCH may carry semi-persistent reports. The scheduler may use the reported CSI when allocating optimal resource blocks (e.g., based on channel's time-frequency selectivity, determining precoding matrices, beams, transmission mode and/or selecting suitable modulation and coding schemes (MCSs)). The reliability, accuracy, and/or timeliness of WTRU CSI reports may be included to meeting ultra reliable low liability communications (URLLC) service requirements.

A WTRU may be configured with a CSI measurement setting. This CSI measurement setting may include one or more CSI reporting settings, resource settings, and/or a link between one or more CSI reporting settings and/or one or more resource settings.

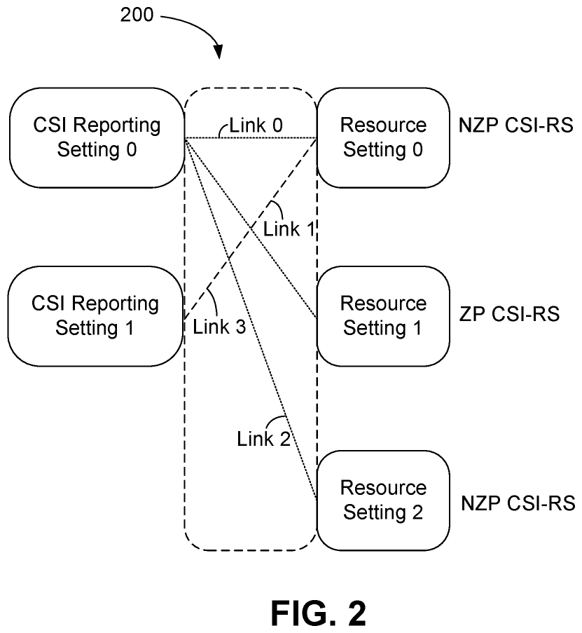

FIG. 2 depicts an example of a configuration 200 for CSI reporting settings, resource settings, and/or link. In a CSI measurement setting, one or more of the following configuration parameters may be provided: a CSI measurement setting may include N≥1 CSI reporting settings; M≥1 resource settings; and/or a CSI measurement setting which links the N CSI reporting settings with the M resource settings.

A CSI measurement setting may include a CSI reporting setting that includes one or more of the following: time-domain behavior (e.g., aperiodic, periodic and/or semi/persistent); frequency-granularity (e.g., for PMI and/or CQI, etc.); CSI reporting type (e.g., PMI, CQI, RI, and/or CRI, etc.); and/or PMI Type (e.g., Type I and/or Type II) and/or a codebook configuration (e.g., if a PMI is reported).

A CSI measurement setting may include a resource setting that includes one or more of the following: time-domain behavior (e.g., aperiodic, periodic and/or semi-persistent); RS type (e.g., for channel measurement and/or interference measurement); and/or S≥1 resource set(s) and/or each resource set may contain Ks resources.

A CSI measurement setting may include one or more of the following: one or more CSI reporting setting(s); one or more resource setting(s); and/or a reference transmission scheme setting (e.g., for CQI).

For CSI reporting for a component carrier, one or more of the following frequency granularities may be supported: wideband CSI, partial band CSI, and/or sub band CSI.

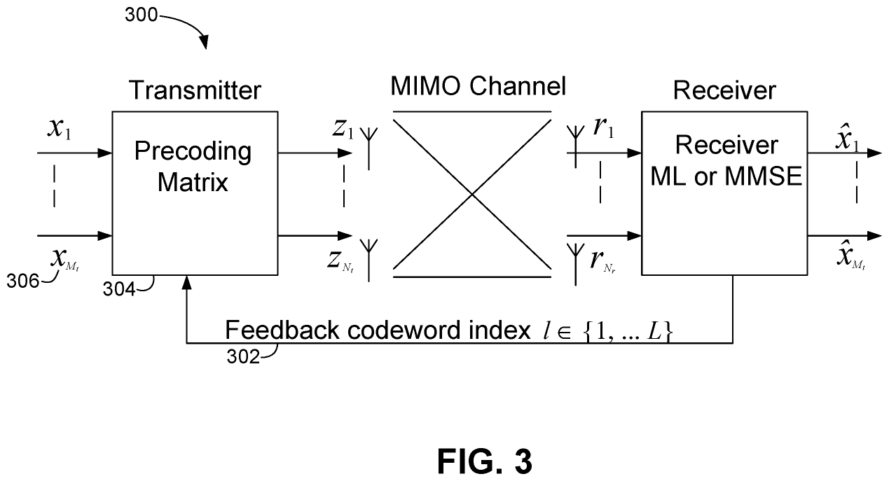

A CSI reporting framework may include codebook based precoding. FIG. 3 illustrates a concept of codebook-based precoding 300 with feedback information 302. The feedback information 302 may include a precoding matrix index (PMI) which may be referred to as a codeword index in the codebook, as FIG. 3 depicts.

As shown in FIG. 3, a codebook 304 may include a set of precoding vectors/matrices 306 for each rank and/or the number of antenna ports. In examples, each precoding vectors/matrices may include an index so that a receiver may inform preferred precoding vector/matrix index to a transmitter. The codebook-based precoding may have performance degradation due to including a finite number of precoding vector/matrix (e.g., as compared with non-codebook-based precoding). However, an advantage of a codebook-based precoding may be lower control signaling/feedback overhead. Table 1 shows an example of codebook for 2Tx.

TABLE 1
2Tx downlink codebook

| Codebook | Number of rank | |
|---|---|---|
| index | 1 | 2 |
| 0 | $\frac{1}{\sqrt{2}} [ \begin{matrix}1 \\ 1\end{matrix} ]$ | $\frac{1}{\sqrt{2}} [ \begin{matrix}1 & 0 \\ 0 & 1\end{matrix} ]$ |
| 1 | $\frac{1}{\sqrt{2}} [ \begin{matrix}1 \\ - 1\end{matrix} ]$ | $\frac{1}{2} [ \begin{matrix}1 & 1 \\ 1 & - 1\end{matrix} ]$ |
| 2 | $\frac{1}{\sqrt{2}} [ \begin{matrix}1 \\ j\end{matrix} ]$ | $\frac{1}{2} [ \begin{matrix}1 & 1 \\ j & - j\end{matrix} ]$ |
| 3 | $\frac{1}{\sqrt{2}} [ \begin{matrix}1 \\ - j\end{matrix} ]$ | — |

The indication of the selected CSI quantization setting may comprise an index of a codebook associated with the plurality of CSI quantization settings.

A CSI reporting framework may include CSI processing criteria. A CSI processing unit (CPU) may be referred to as a minimum CSI processing unit and/or a WTRU may support one or more CPUs (e.g., N CPUs). A WTRU with N CPUs may estimate N CSI feedbacks calculation in parallel, wherein N may be a WTRU capability. The WTRU may perform (e.g., only perform) high priority N CSI feedbacks. The rest may not be estimated if a WTRU is requested to estimate more than N CSI feedbacks at the same time.

The starts and/or ends of a CPU may be determined based on the CSI report type (e.g., aperiodic, periodic, and/or semi-persistent) as described herein. For aperiodic CSI report, a CPU may start to be occupied from the first OFDM symbol after the PDCCH trigger until the last OFDM symbol of the PUSCH carrying the CSI report. For periodic and/or semi-persistent CSI report, a CPU may start to be occupied from the first OFDM symbol of one or more associated measurement resources (e.g., not earlier than CSI reference resource) until the last OFDM symbol of the CSI report. The number of CPUs occupied may be different based on the CSI measurement types (e.g., beam-based and/or non-beam based), as described herein.

Non-beam related reports may include Ks CPUs when Ks CSI-RS resources in the CSI-RS resource set for channel measurement. Beam-related reports (e.g., “cri-RSRP”, “ssb-Index-RSRP”, and/or “none”) may include 1 CPU, irrespective of the number of CSI-RS resources in the CSI-RS resource set for channel measurement, (e.g., due to the CSI computation complexity is low). Beam-related reports that include “none” may be used for P3 operation and/or aperiodic TRS transmission. For an aperiodic CSI reporting with a single CSI-RS resource, 1 CPU may be occupied. For a CSI reporting Ks CSI-RS resources, Ks CPUs may be occupied as the WTRU may perform CSI measurements for each CSI-RS resource.

When the number of unoccupied CPUs (Nᵤ) is less than required CPUs (Nᵣ) for CSI reporting, a WTRU may drop N_r-N_u CSI reporting based on priorities in the case of uplink control information (UCI) on PUSCH without data and/or hybrid automatic repeat request (HARQ). Further, a WTRU may report dummy information in Nr-Nu CSI reporting based on priorities in other case to avoid rate-matching handling of PUSCH.

Artificial intelligence (AI) may be implemented as described herein. Artificial intelligence may be defined as the behavior exhibited by machines. Such behavior may mimic cognitive functions to sense, reason, adapt, and/or perform.

Machine learning (ML) and ML principles may be implemented as described herein. Machine learning may refer to type of algorithms that solve a problem based on learning through experience (e.g., data), without explicitly being programmed (e.g., configuring set(s) of rules). ML may be considered a subset of AI.

Different ML paradigms may be envisioned based on the nature of data and/or feedback available to the learning algorithm. For example, a supervised learning approach may involve learning a function that maps input to an output based on labeled training example, wherein each training example may be a pair consisting of input and/or the corresponding output. For example, an unsupervised learning approach may involve detecting patterns in the data with no pre-existing labels. A reinforcement learning approach may involve performing sequence of actions in an environment to maximize the cumulative reward.

Applying ML algorithms using a combination and/or interpolation of the approaches described herein may be possible. For example, a semi-supervised learning approach may use a combination of a small amount of labeled data with a large amount of unlabeled data during training. Semi-supervised learning may fall between unsupervised learning (e.g., with no labeled training data) and supervised learning (e.g., with only labeled training data).

Deep learning (DL) may be implemented as described herein. DL may refer to a class of ML algorithms that employ artificial neural networks (e.g., specifically deep neural networks (DNNs)), which were loosely inspired from biological systems. The DNNs may be a special class of machine learning models inspired by human brain wherein the input may be linearly transformed and/or pass-through non-linear activation function multiple times. DNNs may consist of multiple layers wherein each layer consists of linear transformation and/or a given non-linear activation functions.

The DNNs may be trained using the training data via back-propagation algorithm. The DNNs may perform in a variety of domains (e.g., speech, vision, and/or natural language, etc.) and/or for various machine learning settings (e.g., supervised, un-supervised, and/or semi-supervised). The term AI/ML based methods and/or processing may refer to realization of behaviors and/or conformance to requirements by learning based on data without explicit configuration of sequence of steps of actions. Such methods may enable learning complex behaviors which might be difficult to specify and/or implement when using legacy methods.

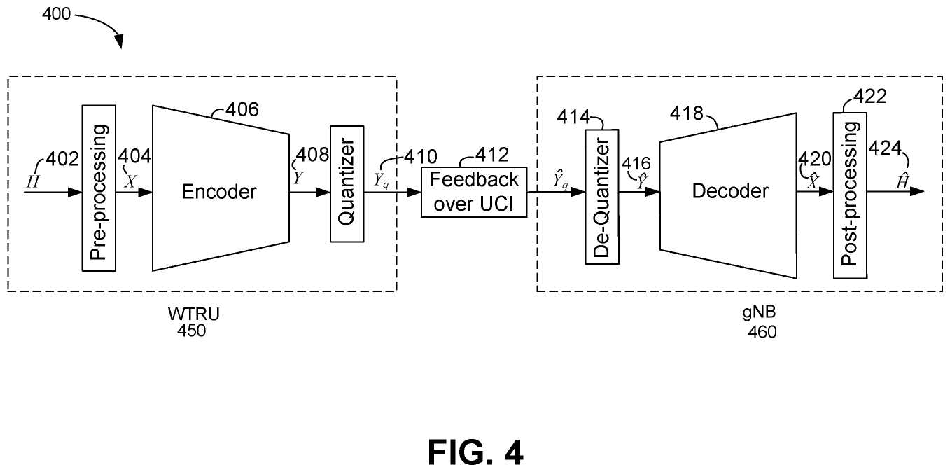

CSI compression may be implemented as described herein. The CSI report to indicate the precoder for MIMO systems may be compressed with the system, as FIG. 4 illustrates. Specifically, FIG. 4 depicts an example of a block diagram 400 of a CSI compression framework. The CSI compression framework may consist of an AE trained to compress the channel matrix 402 and/or the pre-processed channel matrix 404. The channel matrix 402 at the WTRU 450 may be pre-processed and/or compressed with the encoder section 406 of the autoencoder. The encoder output 408 may be quantized at 410 and/or feedback 412 to gNB 460. At the gNB 460 side, de-quantization 414 may be applied and/or the output of the de-quantizer 416 may be fed into the decoder section 418 of the autoencoder. The outputs 420 of the decoder 418 may be post-processed at 422 to obtain the channel matrix 424 of the precoder.

The end-to-end performance of the autoencoder may be measured with the normalized mean squared error (NMSE) metric. The NMSE may be defined as

$$NMSE = \frac{E \{ {‖ H - \hat{H} ‖}^{2} \}}{E \{ {‖ H ‖}^{2} \}} ,$$

where H is the reconstructed channel matrix 424 at the gNB and E{.} denotes the average operation over multiple samples.

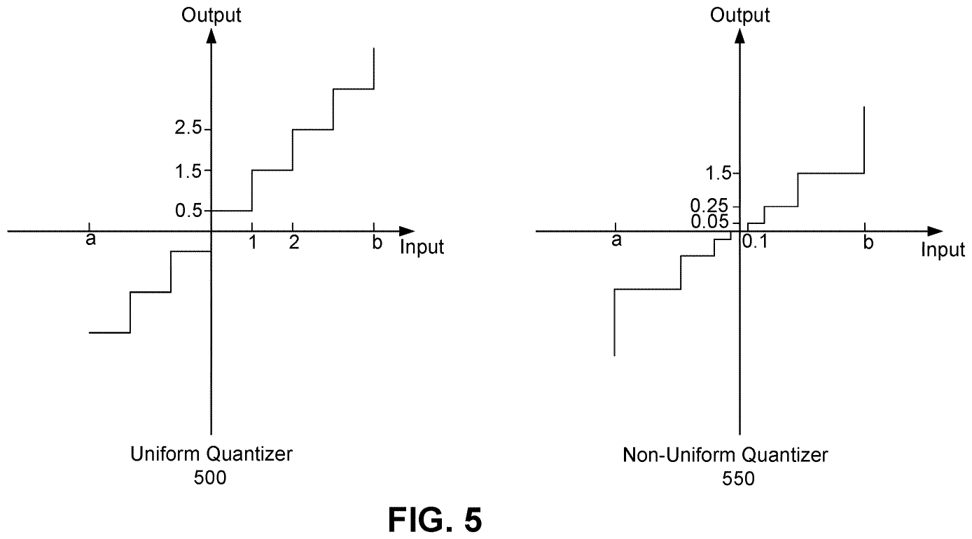

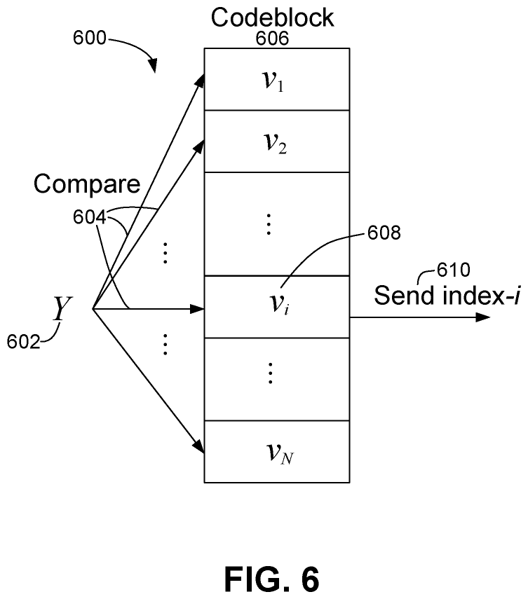

Quantization may be implemented as described herein. Quantization may be used to convert continuous values to a set of discrete values. Various quantization methods may include uniform and/or non-uniform, as shown in FIG. 5, as well as vector quantization, as shown in FIG. 6.

FIG. 5 depicts examples of scalar uniform 500 and/or non-uniform 550 quantizers. Non-uniform 550 quantizers may be used in the cases where the input values occur more frequently around certain values.

FIG. 6 illustrates an example diagram 600 of vector quantization. In vector quantization, the input vector 602 may be compared with one or more (e.g., all) vectors 604 in a codeblock 606 and/or the closest vector's 608 index may be sent to the receiving end at 610. The characteristics of the input vector 602 may determine the vectors 604 in the codeblock 606.

The performance of a quantizer may be measured with quantization noise (QN). The average QN associated with a quantizer may be defined as

$$Average QN = E \{ \frac{{‖ {z}_{in} - {z}_{q} ‖}^{2}}{{‖ {z}_{in} ‖}^{2}} \} ,$$

where zᵢₙ and z_{q} denote the input and the output of the selected quantizer, respectively.

The systems and/or methods proposed herein related to adaptive (e.g., primary) CSI quantization may address one or more problems as described herein. For downlink scheduling and/or link adaptation purposes for both SU- and/or MU-MIMO, knowledge (e.g., accurate knowledge) of the channel may be included. The gNB may obtain the CSI from the WTRU for scheduling and/or link adaptation purposes. The gNB may use DL CSI reference signals (CSI-RS) to enable channel estimation at the WTRU, and/or by feeding back the estimated CSI (e.g., implicit CSI, CQI, PMI, RI, and/or LI) in the WTRU CSI report(s).

However, as NR supports a number of antenna ports, there may be overhead associated to CSI feedback reporting. There may be overhead for CSI Type II codebook (e.g., Rel-15 CSI type II and/or Rel-16/17 Type II/eType II CSI codebook). The overhead may be expected to further increase as the system bandwidth and/or the number of antennas increase in B5G Massive MIMO systems.

AI, including ML, may be applied to reduce the CSI feedback overhead, and/or improve CSI feedback accuracy with similar (e.g., same) overhead, through AI/ML based compression, prediction, and/or both compression and/or prediction.

There may be, however, various challenges associated with supporting artificial intelligence in a 3GPP communication system, and/or within a 3GPP communication protocol stack. In the case of AE based techniques, the encoder-decoder pair may align for correct end-to-end processing.

The CSI framework using AE architectures may include a quantization process to reduce the number of feedback bits. There may be two approaches regarding the quantization step processing. In the first approach, part of the training of the AE architecture may include selection of the quantizer (e.g., quantizer aware training). In the second approach, the AE training and/or quantization process(es) may be separately operated (e.g., quantizer non-aware training). In the first approach, including the quantizer to the training of AE may limit the flexibility of the compression output by requiring separately trained AEs for a given overhead. If the first approach is used, frequently switching between NN structures at both the WTRU and/or the gNB may be required depending on the available feedback overhead.

Vector quantization may be another potential method to address the non-uniform distribution of the encoder. The values of the CSI compression AE's encoder output may be more frequent on low amplitudes (e.g., non-uniformly distributed). Hence, one or more (e.g., traditional) uniform quantizers may not be optimal for AE based compression outputs. Moreover, each encoder output of an AE may show different characteristics on how the values are distributed. Each trained AE may also show different characteristics on the distribution of the encoder output values.

However, vector quantization may be computationally intensive due to the comparison of the input vector to one or more (e.g., all) vectors in the codeblock. Moreover, updating the codeblock of vector quantizer may cause overhead.

Methods and/or enablers on adaptive quantization may be decoupled from AE training but built based on the trained AE. An example method may address the problems related with quantizer aware AE training. The proposed adaptive (e.g., primary) quantizer may adapt to the characteristic(s) of the values of the encoder output of an AE. The quantizer's resolution may be changed immediately to fit the compressed information into the varying UCI overhead. Hence, the proposed systems and/or methods may provide an adaptive and/or flexible framework for determining quantizer(s) that can be applied to one or more (e.g., any) information compression (e.g., with the use of an AE).

Systems and methods for adaptive CSI quantization are described herein. For example, the quantization of the compressed information at the output of the encoder may impact the quality of the decompressed information at the receiving end. In wireless communications, CSI compression may be an example of information compression achieved with an AE. Designing adaptive (e.g., primary) quantizers built based on the characteristics of the encoder output values may increase the efficiency of the quantization.

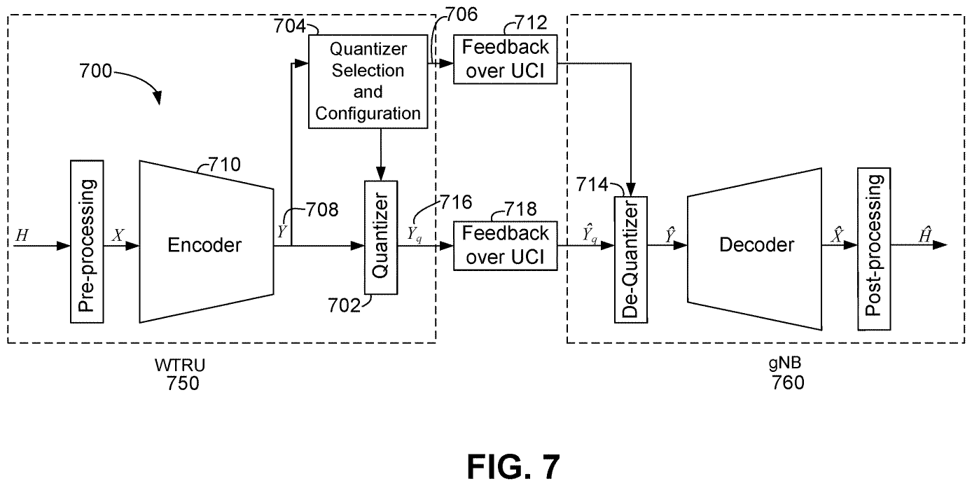

FIG. 7 illustrates a high level view of an adaptive quantization process for CSI compression. The quantizer 702 may be built based on the Quantizer Selection and/or Configuration block's 704 decision(s). The Quantizer Selection and/or Configuration block 704 may determine the quantizer parameter(s) 706 based on the output values 708 of the encoder 710. The quantizer parameter(s) 706 may be fed back via UCI 712 to the gNB 760 for the implementation of the de-quantizer 714. The quantized compressed CSI 716 is fed back to the gNB via 718.

The example high level structure given in FIG. 7 may not be limited to WTRU 750 to gNB 760 communications. The block diagram of the autoencoder 710 and/or quantizer 702 may be applied to gNB 760 to WTRU 750 communications, as well as WTRU to WTRU communications. Additionally or alternatively, the systems and/or methods described herein may not be limited to CSI compression. Rather, the systems and/or methods described herein may be applied to one or more (e.g., any) information compression process(es) that include quantization.

Adaptive CSI quantization is also described herein, including, e.g., the WTRU may have the capability(ies) to select and/or determine parameter(s) of the adaptive (e.g., primary) quantizers and/or monitor their performance. Enabling an adaptive (e.g., primary) quantizer may include processes including initial configuration, determination of quantizer parameters, feedback of the parameters, monitoring, and/or reporting of the quantization performance.

Configuration of adaptive quantization is also described herein, including, e.g. non-codebook based methods and/or procedures for the configuration of the adaptive (e.g., primary) CSI quantizer. The systems, settings, and/or methods may be applicable to one or more (e.g., any) type of quantization including uniform, non-uniform, and/or vector based. A WTRU may be configured, indicated, and/or requested to determine one or more (e.g., multiple) CSI quantizers via one or more of RRC, MAC CE and/or DCI.

The configuration of WTRU to perform adaptive quantization may include one or more of the criteria described herein. For example, the approach the WTRU uses for CSI quantization may include determining the quantizer as part of the AI/ML based CSI framework (e.g., compression, prediction, and/or joint compression and/or prediction). The WTRU may separately determine the quantizer from the AI/ML based CSI framework.

The WTRU may determine the number of CSI quantizers. The WTRU may determine the number of CSI quantizers using single-quantizer methods, where one quantizer for one or more (e.g., all) encoder outputs may be determined, and/or using multiple-quantizer methods. Therein, multiple quantizers, one for each encoder output, may be determined.

The WTRU may use one or more types of methods to determine one or more (e.g., multiple) CSI quantizers by the WTRU. For example, the method may include a distribution method where the WTRU computes the distribution of encoder output values using historical samples. In an example, the gNB may indicate to the WTRU a maximum, a minimum, and/or a range of number(s) of one or more historical samples to use. The WTRU may then select the one or more sample(s) in the range. In an example, the WTRU may use a certain statistical distribution for the determination of the distribution of encoder output values. The type of method the WTRU uses to determine one or more (e.g., multiple) CSI quantizers may include a clustering based method where the WTRU computes centroids for the encoder output values using one or more historical samples. In examples, the gNB may indicate to the WTRU how many number of centroids to determine for the CSI quantizer(s).

The WTRU may use performance metrics (e.g., KPIs) to monitor the performance of the adaptive (e.g., primary) quantizer determined by the WTRU. In examples, the KPIs used to monitor the performance of adaptive (e.g., primary) quantizer determined by the WTRU may include quantization noise. The quantization noise may include a configuration including one or more (e.g., multiple) thresholds for CSI quantization noise. The KPIs used to monitor the performance of adaptive (e.g., primary) quantizer determined by the WTRU may include NMSE. In examples, NMSE may include a configuration including one or more (e.g., multiple) thresholds for NMSE.

A WTRU may receive configuration information from a network node (e.g., gNB). The configuration information may indicate a plurality of channel state information (CSI) quantization settings and/or criteria for selecting from the plurality of CSI quantization settings. The WTRU may perform one or more CSI measurements on one or more reference signals. The WTRU may encode the one or more CSI measurements. The WTRU may select a CSI quantization setting of the plurality of quantization settings based on the criteria indicated in the configuration message. The WTRU may quantize the encoded one or more CSI measurements using the selected CSI quantization setting. The WTRU may send a feedback report comprising the quantized one or more CSI measurements and/or an indication of the selected CSI quantization setting to the network node.

The configuration of the WTRU to perform adaptive quantization may include the configuration of fallback CSI quantization. Fallback CSI quantization may include configuring a secondary quantizer and/or set of quantizers as a fallback. For example, the WTRU may use a legacy (e.g., uniform) CSI quantizer as a fallback.

The WTRU may use feedback mechanisms to signal the determined quantizers and/or sets of quantizers to the gNB. The feedback mechanisms may include explicit signaling methods. In examples, the WTRU may signal the selected quantizers and/or sets of quantizers as part of the CSI report (e.g., using PUSCH and/or PUCCH, depending on the configuration of the CSI report). In examples, the WTRU may signal the selected quantizers and/or sets of quantizers, using uplink control signaling (e.g., using UCI and/or PUCCH). In examples, the WTRU may be configured to signal the selected quantizers and/or sets of quantizers, using MAC CE. The feedback mechanisms for the WTRU to signal the determined quantizers and/or sets of quantizers to the gNB may include implicit signaling methods. In examples, the WTRU may signal the selected quantizers and/or sets of quantizers implicitly, by selection of certain UL resources (e.g., PUSCH, PUCCH, and/or sounding reference signals (SRS)).

The WTRU may determine the quantizer (e.g, including criteria around type, number, method, and/or KPIs, etc.) in a self-configured fashion. The configuration of adaptive quantization by the WTRU may utilize implicit methods to determine parameters. Such parameters may include methods implicitly determined based on parameters, training conditions, and/or use-case (e.g., pre-defined conditions).

Based on the configuration and/or set of configurations, the WTRU may receive and/or request one or more RS and/or RS sets to determine the quantizer.

The parameters of quantization may be determined with gNB configuration, as described herein. The procedures when the WTRU determines the quantization parameters with the indicated configurations are described herein.

A WTRU may be configured with the type of method to determine the parameters of the CSI quantizer. For example, the method may be distribution-based and/or clustering-based. Additionally or alternatively, a WTRU may be configured with single-quantizer option. In the single-quantizer option, the same quantizer may be used for one or more (e.g., all) encoder outputs, and/or multiple-quantizer options where different quantizers may be used for the encoder outputs.

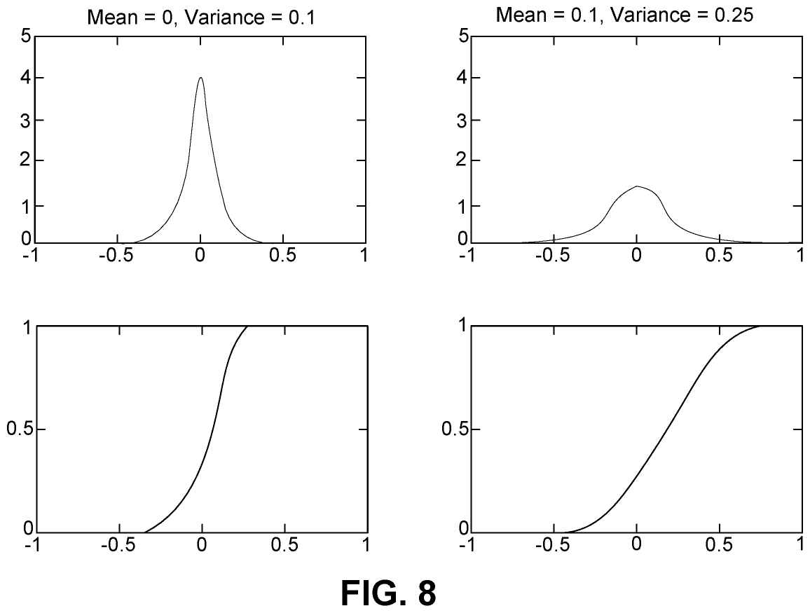

A distribution-based quantizer method may be described herein. The values of the outputs of the encoder of the AE may be distributed non-uniformly between the minimum and/or maximum values of the encoder outputs. The distribution may have a characteristic of being Gaussian and/or any other distribution. FIG. 8 illustrates examples of distributions of the encoder output values based on Gaussian distribution, including probability density functions (PDF) and/or cumulative distribution functions (CDF).

A non-uniform quantizer may quantize the encoder output values. The non-uniform quantizer may be built by one or more (e.g., any) method implicit to both ends, e.g., given the parameters of the distribution. In case of Gaussian distributed encoder output values, the mean and/or variance of the distribution may be sufficient to determine the parameters of the distribution and/or build the quantizer.

In order to compute the PDF and/or CDF of the encoder output values, the WTRU may collect historical sample values for the output of encoder of the AE. The number of samples may be pre-defined and/or implicit depending on gNB indication.

An example method to build the non-uniform quantizer, given the distribution and/or the quantizer's parameters, may be the CDF transform followed by uniform quantizer. The transform F(x) may be uniformly distributed between 0 and 1, where F represents the CDF of x, for example, assuming that x represents a non-uniform distributed value to be quantized.

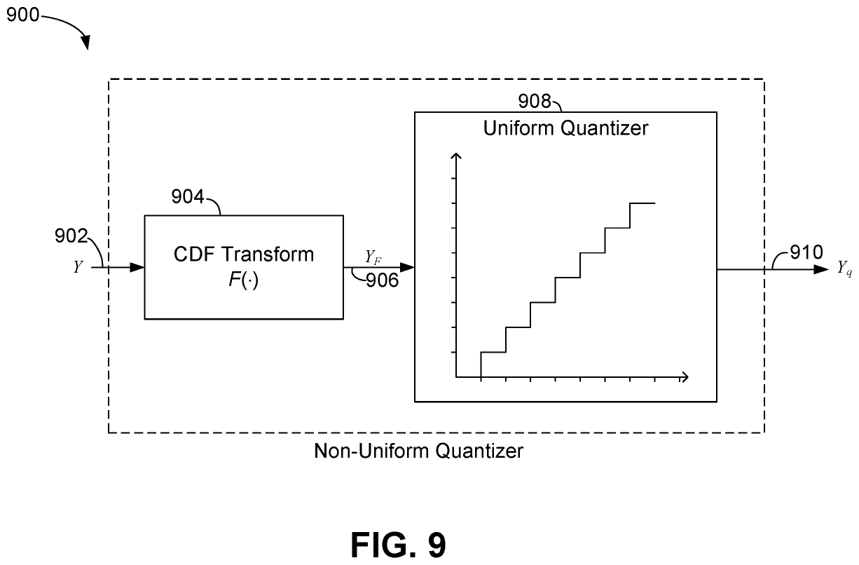

FIG. 9 illustrates the non-uniform quantization process 900 that includes determining the parameters of the distribution. The output values of the encoder Y 902 may be applied the CDF transform 904. The transformed values Y_{F} 906 may be applied to the uniform quantizer 908. The output of the quantizer, Y_{q} 910, may include a certain number of bits depending on the resolution of the quantizer 908.

To determine the number of steps (e.g., resolution) of the quantizer, in examples, UCI feedback overhead and/or number of encoder outputs may be used. For example, if the number of encoder outputs is N=10 and/or the UCI overhead is U=60 bits, each output value may be represented with U/N=6 bits leading to 64 steps in the quantizer.

In case the distribution is implicit and/or indicated by the WTRU, the WTRU may feed back the parameters of the distribution to the gNB (e.g., mean and/or variance, assuming Gaussian distribution output values). In case the distribution cannot be identified as an explicit distribution, the CDF obtained from the histogram of the output values may be used for the CDF transform operation. In that case, the CDF may be fed back to the gNB.

Cluster-based quantizer methods are also described herein. For example, the WTRU may build clustering-based quantizer(s). Historical samples from the output of the encoder may be collected. The number of historical samples can be implicit and/or indicated by the gNB. A clustering method, such as k-means, may partition the historical samples into one or more clusters (e.g., a certain number).

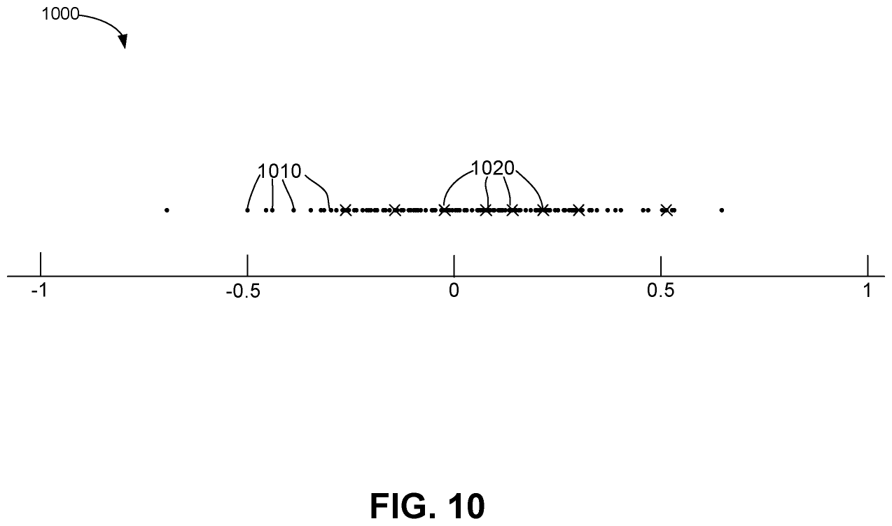

FIG. 10 illustrates an example for the clustering 1000 for the output values of encoder assuming the output is Gaussian distributed with mean 0.1 and/or variance 0.1. For illustration, 100 historical samples may be collected and/or partitioned into 8 clusters using k-means method. FIG. 10 depicts dots 1010 that may represent the samples values and/or x-marks 1020 that may represent the cluster means (e.g., centroids).

As FIG. 10 illustrates, for example, the centroids may be non-uniformly spaced depending on the historical samples. Following the computation of cluster centroids, the centroid values may be fed back to the gNB for de-quantization process.

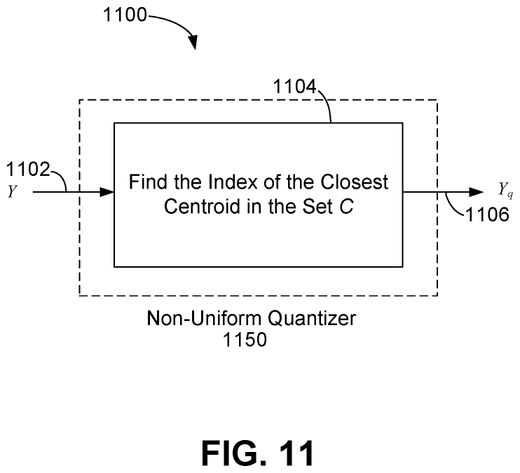

FIG. 11 illustrates the quantization process at the WTRU after the computation of the centroids. For each value Y 1102 to be quantized, the non-uniform quantizer 1150 may search for the closest centroid in the centroid set C computed in the clustering phase at 1104. The output of the quantizer Y_{q} 1106 may represent the index of centroid and/or include a certain number of bits, (e.g. depending on the number of centroids). The number of clusters and/or centroids may be determined based on the UCI overhead and/or the number of encoder outputs. For example, if the encoder has N=10 outputs and/or the UCI overhead is U=60 bits, U/N=6 bits may be used to represent a cluster centroid, meaning that 64 clusters may be computed.

Modifications may be performed based on the number of quantizers, as described herein. For example, the WTRU may be indicated to build a single quantizer to use for one or more (e.g., all) encoder outputs and/or multiple quantizers to quantize the encoder outputs separately. In case the WTRU is indicated to build single quantizer, historical samples from one or more (e.g., all) outputs of the encoder may be combined. If the distribution-based method is indicated, the combined samples may be used to compute a single histogram for the encoder output values that are used to compute PDF and/or CDF. If the clustering-based method is indicated, the combined samples may be used to compute a single set of centroids.

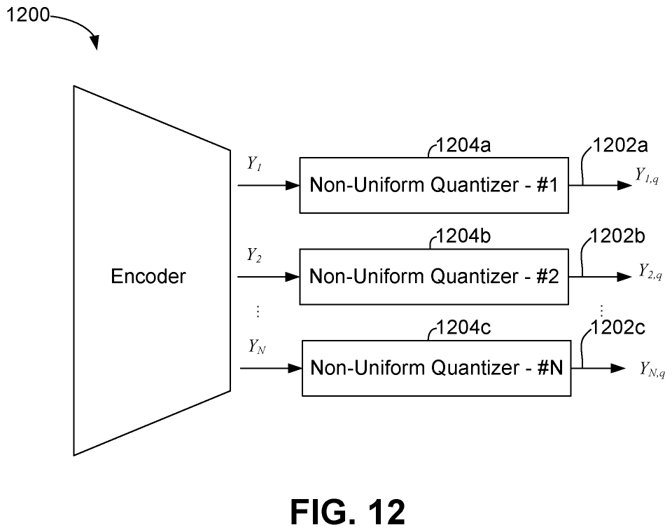

In case the WTRU is indicated to build multiple quantizers, samples from each encoder output may be collected separately. For example, assuming there are 10 encoder outputs, 10 sets of historical samples may be collected. If the distribution-based method is indicated, separate histograms may be computed for each encoder output. If the clustering-based method is indicated, separate sets of centroids may be computed for each encoder output. FIG. 12 illustrates an example of the quantization structure 1200 for multiple-quantizers wherein each encoder output 1202a-c may be applied separate quantizers 1204a-c.

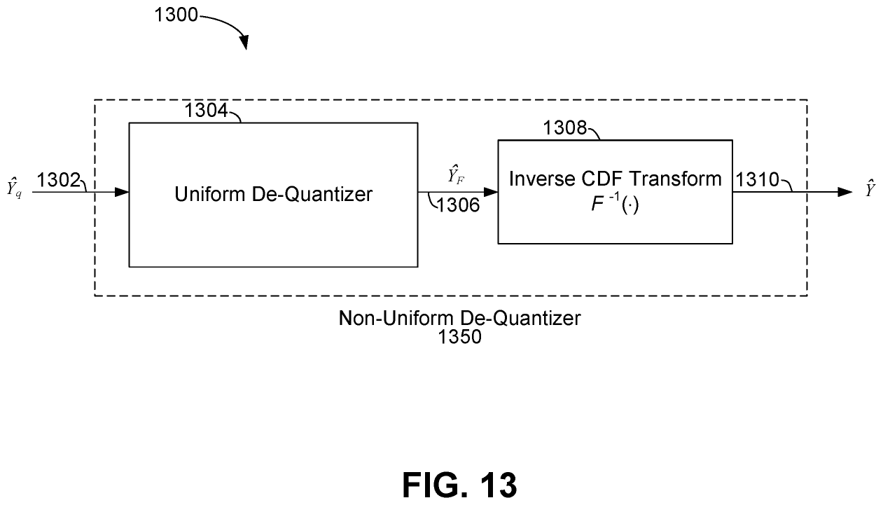

A de-quantization process with distribution-based method is described herein. For example, when the receiving end receives the feedback on quantization parameters, such as another WTRU and/or gNB, the de-quantizer may be built. In case of distribution-based quantization, the receiving end may already have received feedback on the parameters of the distribution. FIG. 13 illustrates an example non-uniform de-quantizer 1350 for distribution-based method 1300 where the received quantized encoder output values Ŷ_{q} 1302 may be de-quantized with uniform de-quantizer 1304 where each Ŷ_{q} 1302 is mapped to a scalar value Ŷ_{F} 1306. The scalar value Ŷ_{F} 1306 may be applied inverse CDF transform F⁻¹(·) 1308 to obtain the dequantized value Y 1310.

A de-quantization process with clustering-based method is described herein. For example, in the clustering-based approach, the receiving end (e.g., another WTRU and/or gNB) may receive an indication for the centroids of the clusters. A de-quantizer at the receiving end may map the received index of the centroid to the actual value of the centroid.

The parameters of the quantizer may be determined with WTRU self-configuration, as described herein. The procedures when the WTRU determines the quantization parameters with self-configuration may be described herein.

For example, when the WTRU is configured for self-configuration, the WTRU may include determining quantization performance metric(s), type of method to determine the quantizer, number of quantizers, and/or secondary quantizer. One or more (e.g., all) determined configurations may feed back to the gNB.

The WTRU may determine the quantization performance metric. The selection of the quantization performance metric may be implicit based on the current state of the WTRU (e.g., velocity and/or received signal strength indicator (RSSI), etc). The WTRU may determine the quantization performance metric using a look-up table approach. The WTRU may determine a quantizer based on indices associated with a predefined look-up table. Example quantization performance metrics may include QN and/or NMSE.

In examples, the selection of the quantization performance metric may depend on the capability(ies) of the WTRU. For example, if the UE has access to the decoder part of the AE, the WTRU may select NMSE. Otherwise, the WTRU may select QN as the performance metric.

The WTRU may determine the type of method to determine the parameters of quantizer. The selection of the type of quantizer may be implicit, for example, based on the current state of the WTRU (e.g., velocity and/or RSSI, etc.). The WTRU may determine the quantization type using a look-up table approach. Example quantization types may be uniform, distribution-based, and/or clustering-based, etc.

In examples, the WTRU may build one or more quantizer (e.g., distribution-based, and/or clustering-based) and/or compare their performance based on, for example, the selected quantization performance metric. The WTRU may use historical samples to build the quantizers and/or use one or more (e.g., any) pre-defined quantizer. The comparison of the performance may be based on the average of the performance metrics computed using one or more (e.g., all) historical samples. The WTRU may select the quantizer with the strongest performance metric.

The indication of the selected CSI quantization setting may include an indication of a quantization type, a quantization parameter, a quantizer granularity, and/or a resolution of the quantizer.

The WTRU may determine the parameters of the quantizer after the WTRU selects the type of the quantizer. For example, in case of distribution-based method, the distribution parameters (e.g., mean and/or variance), and/or the CDF may be feedback to the gNB.

The WTRU may determine the number of quantizers. The selection of the number of quantizers (e.g., single quantizer for one or more (e.g., all) outputs and/or one per output, etc.) may be implicit based on the current state of the WTRU (e.g., velocity and/or RSSI, etc.). In examples, the WTRU may determine the number of quantizers using a look-up table approach. The WTRU may build one or more (e.g., all) options on the number of quantizers and/or compare their performance based on the selected quantization performance metric. The WTRU may use historical samples to build the quantizers. The comparison of the performance may be based on, for example, the average of the performance metrics computed using one or more (e.g., all) historical samples. The WTRU may select the option with the strongest performance metric.

The WTRU may determine the secondary quantizer. The selection of the secondary quantizer may be implicit based on the current state of the WTRU (e.g., velocity, RSSI, etc.). The WTRU may determine the number of quantizers using a look-up table approach. In examples, the WTRU may build one or more (e.g., all) secondary quantizer options and/or compare their performance. The WTRU may select the option with strongest performance. The WTRU may select the secondary quantizer based on second criteria, and wherein the second criteria comprises the current state of the WTRU's current state velocity or received signal strength indicator (RSSI). The performance of the primary and secondary quantizers may be measured via quantization noise (QN), cosine similarity, squared generalized cosine similarity (SGCS).

The WTRU may feedback the quantizer parameters. One or more (e.g., all) determined configurations such as quantization performance metric, type of quantizer, parameters of the quantizer, number of quantizers, and/or secondary quantizer may be fed back to the gNB. The WTRU may feedback the information for the gNB to build the de-quantizer.

The feedback of the quantization parameters may be performed, as described herein. One or more methods in the context of quantization performed by the WTRU and/or de-quantization performed at the gNB may be considered as examples and/or the methods may be applicable (e.g., equally applicable) to any case where the quantization and/or de-quantization may be performed by the WTRU, gNB, and/or any other network node.

One or more systems and/or methods, as described herein, in the context of WTRU to gNB transmissions may be considered examples. These systems and/or methods may apply (e.g., equally applicable) to cases of WTRU-to-WTRU transmissions, gNB-to-WTRU transmissions, and/or to transmissions between one or more (e.g., any) WTRUs.

One or more systems and/or methods, as described herein, in the context of quantizing CSI feedback may be considered examples. The systems and/or methods may apply (e.g., equally applicable) to quantizing any type of feedback and/or to any transmission.

Feedback of quantization parameters may include example quantizer feedback contents, as described herein. In examples, the term quantization feedback may include one or more of the following: indication of recommended quantization type and/or a set of quantization types (e.g., uniform quantization, non-uniform quantization, scalar quantization, and/or vector quantization etc.), method to build the quantizer (e.g., distribution based and/or clustering based, etc.) and/or parameterization thereof (e.g., mean and/or variance of distribution, index of cluster centroids, value of centroids, and/or number of clusters, etc.), granularity and/or number of applicable quantizers (e.g., quantizer specific to each encoder output, quantizer common for each encoder output, and/or single quantizer for all the encoder output, etc.), resolution of the quantizer (e.g., quantization range, quantization error, quantization overhead, and/or number of bits, etc.), indication of fallback quantizer and/or a set thereof, indication of operating condition (e.g., use case, RSSI, SINR, WTRU speed, performance metric associated with the quantizer etc.) that may implicitly determine the quantizer, and/or parameterization thereof. In examples, the WTRU may be configured to transmit the quantization feedback to indicate the recommended quantization parameters and/or set of recommended quantization parameters to indicate the selected quantizer and/or a subset of quantizers.

Feedback of quantization parameters may include transmission of quantizer feedback in MAC-CE. In examples, the WTRU may be configured to transmit the quantization feedback semi-statically. The WTRU may receive an activation command from the gNB, e.g. in a DL MAC CE, to activate semi-persistent reporting of quantization feedback. The WTRU may transmit the quantization feedback in a UL MAC CE.

The WTRU may receive configuration of quantization feedback in the DL MAC CE that activates the quantization feedback reporting. For example, the configuration may include the type of quantization feedback, content of quantization feedback, size of quantization feedback, and/or periodicity of quantization feedback, etc. The WTRU may receive configuration associated with quantization feedback transmission in a RRC message. In examples, the WTRU may receive one or more (e.g., multiple) sets of configurations associated with quantization feedback transmission in a RRC message. The WTRU may determine the appropriate quantization feedback configuration, for example, based on indication in the DL MAC CE. In examples, the WTRU may be configured with set of quantization parameters and/or range thereof. The WTRU may transmit the quantization feedback, for example, such that the reported parameters are within the configured set or range. The WTRU may stop/suspend the quantization feedback transmission, for example, upon receiving deactivation command from the gNB possibly in a DL MAC CE.

Feedback of quantization parameters may include transmission of joint quantizer feedback and/or CSI feedback in UCI. In examples, the WTRU may be configured to transmit the quantization feedback dynamically. For example, the WTRU may transmit the quantization feedback in a UCI and/or L1 reporting/feedback. In examples, the WTRU may transmit the quantization feedback as a part of CSI feedback. For example, the WTRU may receive one or more aspect(s) of quantization feedback configuration in a CSI-MeasConfig. The WTRU may transmit quantization feedback as new report quantity. The WTRU may transmit quantization feedback if configured with report quantity as cri-PMI-QNF—wherein the QNF may indicate that the WTRU should include quantization feedback along with the CSI feedback carrying CRS resource indication and/or precoding matrix indication. The WTRU may determine the content of quantization feedback based on, e.g., an indication received in aperiodic CSI report request message.

Feedback of quantization parameters may include transmission of independent quantizer feedback and/or CSI feedback in UCI. In examples, the WTRU may be configured to transmit the quantization feedback independently of the CSI feedback. The term independently herein may refer to transmissions performed at different time scales and/or transmissions, initiated by different triggers, conditions, and/or transmissions performed on a control message dedicated for quantization feedback. In examples, the WTRU may be configured with dedicated PUCCH resources for quantization feedback.

The WTRU may determine the type and/or content of quantization feedback as a function of allocated of PUCCH resource. For example, the WTRU may be configured with a first set of PUCCH resources associated with the first set of quantizer configurations/feedback and/or a second set of PUCCH resources associated with the second set of quantizer configurations/feedback. The WTRU may select the PUCCH resource based on, for example, determined quantizer feedback. The WTRU may be configured with PUSCH resource and/or PUCCH resource for quantizer feedback transmission. The WTRU may determine whether PUSCH and/or PUCCH resource should be selected for transmission based on content of quantization feedback.

Feedback of quantization parameters may include implicit indication of quantizer feedback. In examples, the WTRU may be configured with plurality of PUCCH resources wherein each PUCCH resource may be associated with a quantizer type and/or quantizer parameterization. The WTRU may implicitly indicate a parameterization of quantizer, for example, based on the choice of PUCCH resource. The WTRU may indicate a first part of quantizer feedback based on the selection of PUCCH resource and/or a second part of quantizer feedback in the content of UCI transmission on the selected PUCCH resource. In examples, the WTRU may indicate the quantizer type via selection of PUCCH resource and/or the recommended quantizer parameterization via the quantization feedback transmitted in the selected PUCCH resource. The WTRU may indicate the quantizer feedback based on the selection of PUCCH resources and/or the CSI feedback in the content of UCI transmission on the selected PUCCH resource. The WTRU may indicate that the WTRU applies a specific quantization based on selecting preconfigured PUCCH resource and/or transmit the quantized CSI feedback on the selected PUCCH resource.

The WTRU may transmit quantizer feedback based on one or more preconfigured conditions and/or triggers. For example, the WTRU may be configured to trigger quantizer feedback transmission when the performance of current active quantizer goes below a threshold. For example, the WTRU may be configured to trigger quantizer feedback transmission when a change in quantizer performance exceeds the performance of current active quantizer by a preconfigured threshold-under the hypothesis that the gNB applies the WTRU recommended quantizer feedback. The WTRU may trigger quantizer feedback transmission upon a change in configuration of CSI feedback and/or in active bandwidth part. For example, the WTRU may trigger quantizer feedback transmission based on preconfigured WTRU measurement. Moreover, the WTRU may trigger quantizer feedback when the SINR, RSRP, and/or the like change by a preconfigured threshold.

The WTRU may apply the updates to quantizer parameters based on the indication received from the gNB. For example, the WTRU may receive an indication from the gNB (e.g., in a DCI) that acknowledges that the gNB has applied the recommended quantizer parameters reported by the WTRU in quantizer feedback. The indication may be implicit wherein the WTRU may update the quantizer parameter according to the most recent transmission of quantizer feedback. The WTRU may receive an explicit indication from the gNB that indicates a logical identity associated with the quantizer feedback transmitted by the WTRU. The WTRU may apply the quantizer update at the preconfigured time offset from the DCI carrying the indication. The WTRU may receive a complete (e.g., full) configuration of quantizer parameterization in a MAC CE and/or a RRC message.

Quantization performance may be monitored and/or reported, as described herein. A WTRU may monitor the quantization performance based on one or more preconfigured metric(s) (e.g., NMSE, QN, cosine similarity, SGCS, and/or PDSCH performance). A WTRU may monitor the performance of the selected/designed/primary quantizer. In examples, the primary quantizer may indicate the quantizer used at the current time instant and/or the secondary quantizer(s) may represent one or more (e.g., all) of the other configured quantizers that are not used at the current time instant. The WTRU may monitor the quantization performance through comparing the performance of the primary quantizer with that of the secondary quantizers (e.g., if configured).

The performance may be based on a one or more preconfigured metrics (e.g., NMSE, QN, cosine similarity, SGCS, physical downlink shared and/or channel (PDSCH) performance). The WTRU may use the QN metric to monitor the primary quantizer performance. The QN associated with any of the preconfigured quantizer may be defined as

$$Q N = \frac{{‖ {z}_{in} - {z}_{q} ‖}^{2}}{{‖ {z}_{in} ‖}^{2}} ,$$

where zᵢₙ and z_{q} denote the output of the AI encoder model and the output of the selected quantizer, respectively. The WTRU may still use the primary quantizer in the next transmission for quantizing the compressed CSI, for example, if the QN of the primary quantizer is less than a preconfigured QN threshold (Eth) by the gNB. The WTRU may compute the QN of the secondary quantizers and/or select the one that results in the minimum QN, for example, if the QN of the primary quantizer exceeds the preconfigured QN value. The WTRU may still use the primary quantizer in the next transmission and/or report that the configured QN threshold is not met if the QN of the primary quantizer is still smaller than the minimum QN across all secondary quantizers.

A WTRU may transmit quantization information (e.g., the selected quantizer and/or parameters thereof) as part of the CSI report, and/or the WTRU may transmit the quantization performance either periodically and/or non-periodically (e.g., if triggered to report one or more metric associated with the quantization performance).

A WTRU may report quantization information as part of the ML based CSI report. The quantization information may include the primary quantizer performance collected over a particular period. The quantization information may also include the selected primary quantizer parameters and/or part thereof.

For performance monitoring, the WTRU may also send one or more of the following parameters: the WTRU may send QuantizerPerformance Threshold for performance monitoring. QuantizerPerformance Threshold may include a binary value indicating whether the quantizer performance is satisfying a preconfigured threshold or not.

The WTRU may send QuantizerSwitch for performance monitoring. QuantizerSwitch may include a binary value indicating whether the WTRU switched to one of the secondary quantizers and/or still uses the primary one used in the previous transmissions.

The WTRU may send QuantizerPerformanceMetric for performance monitoring. QuantizerPerformanceMetric may take several values (e.g., four) where each value indicates which metric is used to monitor the quantization performance. The gNB may also configure QuantizerPerformanceMetric.

The WTRU may send QuantizerPerformance for performance monitoring. QuantizerPerformance may include a parameter indicating the primary quantizer performance and/or QuantizerPerformance may take several values depending on the QuantizerPerformanceMetric value. The QuantizerPerformance may take up to 16 NMSE levels with 1 dB resolution, e.g., if QuantizerPerformanceMetric value is set to NMSE.

The WTRU may be configured to indicate one or more of the parameters as described herein (e.g., periodically, semi-periodically and/or non-periodically), and/or some parameters may be configured to report periodically and/or others non-periodically. For example, the WTRU may report the quantizer performance every N slots, whenever the performance falls below some preconfigured threshold, and/or whenever the WTRU detects use of a secondary quantizer. The WTRU may periodically report the quantization performance. The gNB may indicate whether the WTRU should switch to a secondary quantizer. The WTRU may explicitly send the parameters of the preferred secondary quantizers and/or the gNB may configure the WTRU to switch to any secondary quantizer, if the gNB indicates that the WTRU should switch to a secondary quantizer.

Quantizer fallback may be implemented, as described herein. Quantizer fallback may include quantizer error event configuration. A WTRU may monitor the performance of the quantizer and/or set of quantizers (e.g., primary and/or secondary quantizers) to detect when quantizer error events occur. The WTRU may be configured with a QuantizerError Threshold to detect the error events. For example, the QuantizerErrorThreshold may represent the maximum acceptable quantization noise when the WTRU is configured with QN for QuantizerPerformanceMetric. RRC signalling may configure the WTRU with QuantizerError Threshold, and/or QuantizerPerformanceMetric.

Quantizer allback may be implemented using certain triggers. For example, a quantizer fallback may trigger upon detection of quantizer error events. Triggers for quantizer fallback may include the measured performance of the configured quantizer (e.g., or set of quantizers) that meets a configured threshold. Triggers for quantizer fallback may include measured performance of the configured primary quantizer (e.g., or set of primary quantizers) and/or measured performance of the secondary quantizer (e.g., or set of secondary quantizers) if configured, meets a configured error threshold. An error event (e.g., trigger for quantizer fallback) may be detected when the measured QuantizerPerformance (e.g., NMSE and/or QN) exceeds a configured error threshold (e.g., NMSE and/or QN). In examples, the threshold may be QuantizerErrorThreshold, if the WTRU is configured with NMSE and/or Quantization Noise (QN) as QuantizerPerformanceMetric.

Quantizer fallback may be implemented while the WTRU collects historical samples (e.g., compressed values at the ML encoder output) to determine the quantizer parameters. The number of historical samples may be pre-defined and/or may be configured by the gNB, for example by RRC signalling (e.g., in CSI-MeasConfig). The WTRU may start counting the number of compressed CSI samples (e.g., for the collection of historical samples) upon a change of the CSI-RS configuration. The WTRU may start counting the number of compressed CSI samples (e.g., for the collection of historical samples) when the WTRU uses a new quantizer.

Quantizer fallback mechanisms may be implemented, as described herein. For example, when a quantizer fallback triggers, the WTRU may switch to a secondary (e.g., secondary set) of quantizers. The WTRU may switch if the performance of the secondary quantizer is stronger than the configured quantization error threshold. When a quantizer fallback triggers, the WTRU may switch to a default quantizer if no secondary quantizer and/or set of quantizers are configured. When a quantizer fallback triggers, the WTRU may continue to use the current quantizer, and/or send an indication to the gNB requesting switch to a fallback quantizer. Moreover, the WTRU may switch legacy CSI reports if the performance of the default quantizer is weaker than the configured quantization error threshold.

Examples of default quantizers may include uniform quantizers, where the number of bits is pre-defined and/or non-uniform quantizers, with predefined parameters.

Quantizer fallback event reporting may be performed, as described herein. When a WTRU detects that a quantizer error event occurred, the WTRU may report the quantizer fallback. The report may include QuantizerPerformance, which may include measured quantizer performance. The report may include QuantizerSwitch, which may denote a flag indicating whether the WTRU has switched quantizers. The report may include Quantizer ID, which may denote the ID of the new quantizer, e.g., when the WTRU autonomously switched quantizer upon detection of the error event. In examples, the WTRU may send a request to the gNB for a quantizer switch upon detecting a quantization error event.

Quantization-codebook based adaptive CSI quantization may be implemented as described herein. The WTRU may have the capability to select and/or determine parameters of the adaptive (e.g., primary) quantizers and/or monitor the performance. The WTRU may determine one or more parameters of codebooks for a predefined CSI quantizer. Enabling an adaptive (e.g., primary) quantizer may include steps for initial configuration, determination of quantizer parameters, feedback of the parameters, monitoring, and/or reporting of the quantization performance.

The configuration of adaptive quantization is described herein. Codebook based methods and/or procedures for the configuration of the adaptive (e.g., primary) CSI quantizer are also described herein. Systems and/or methods may apply to one or more (e.g., any) type of codebooks of quantizers including unform, non-uniform, and/or vector based. A WTRU may be configured, indicated, and/or requested to select one or more (e.g., multiple) CSI quantizers via one or more or RRC, MAC CE, and/or DCI (e.g., both dynamic and/or semi-static options are possible), to align the quantizers at WTRU and/or gNB. For example, the WTRU may receive configuration information from a network node. As noted below, the configuration information may include CSI quantization settings and/or criteria for selecting from the CSI quantization settings.

The configuration of WTRU to perform codebook based adaptive CSI quantization may include one or more criteria (e.g., for selecting from the CSI quantization settings). The WTRU may use different approaches for CSI quantization. In examples, the approach may include a quantizer determined as part of the AI/ML based CSI framework (e.g., compression, prediction, and/or joint compression and/or prediction). Moreover, the WTRU may approach CSI quantization by determining the quantizer separately from the AI/ML based CSI framework. The WTRU may determine one or more parameters of codebooks for a predefined CSI quantizer.

The WTRU may determine the number of CSI quantizers from the predetermined codebooks. The WTRU may determine the number of CSI quantizers from the predetermined codebooks using single-quantizer methods, where codebooks may determine one quantizer for one or more (e.g., all) encoder outputs. In examples, the WTRU may determine the number of CSI quantizers from the predetermined codebooks using multiple-quantizer methods, where codebooks may determine multiple quantizers, one for each encoder output.

Different types of methods may be implemented by the WTRU to determine one or more CSI codebook quantizers. The method implemented by the WTRU to determine one or more (e.g., multiple) CSI codebook based quantizers may include one or more predefined codebooks and/or a set of codebooks known to the WTRU and/or gNB. The WTRU may select the respective quantizer and/or sets of quantizers based on indices referring to pre-defined look-up tables. In examples, the WTRU may determine one and/or a set of parameters of codebooks related to pre-defined CSI quantizers.

Performance metrics (e.g., KPIs) may monitor the performance of adaptive (e.g., primary) quantizers determined by the WTRU. The KPIs may include QN. The configuration may include one or more (e.g., multiple) thresholds for CSI quantization noise. The KPIs used to monitor the performance of adaptive (e.g., primary) quantizer may include NMSE. In examples, the configuration may include one or more (e.g., multiple) thresholds for NMSE.

The configuration of the WTRU may include the configuration of fallback CSI quantization. The fallback CSI quantization may include configuring a secondary quantizer and/or a set of quantizers as fallback. In examples, the WTRU may be configured to use legacy (e.g., uniform) CSI quantizer as fallback.

The WTRU may use different feedback mechanisms to signal the determined codebook based quantizers and/or sets of quantizers to the gNB, to align the quantizers at WTRU and/or gNB. The feedback may be provided using explicit signaling methods. In examples, the WTRU may signal the selected quantizers and/or sets of quantizers as part of the CSI report (e.g., using PUSCH and/or PUCCH, depending on the configuration of the CSI report). In examples, the WTRU may signal the selected quantizers and/or sets of quantizers using uplink control signaling (e.g., using UCI and/or PUCCH). The feedback may be provided using implicit signaling methods. The WTRU may signal the selected quantizers and/or sets of quantizers implicitly by selection of certain UL resources (e.g., PUSCH, PUCCH, and/or SRS).

The WTRU may use codebooks to configure adaptive quantization to utilize implicit methods to determine parameters. Such parameters may include, for example, implicitly determined based on parameters, training conditions, and/or use-case, etc. (e.g., pre-defined conditions). The WTRU may receive and/or request one or more RS and/or RS sets to determine the quantizer based on the configuration and/or set of configurations.

The quantizer may be selected as described herein. A WTRU may be configured with and/or maintain and/or design multiple quantizers and/or multiple sets of quantizers. For any one feedback, the WTRU may use a set of quantizers. A set of quantizers may define the multiple quantizers used for different outputs of an AI/ML model. A set of quantizers may include fewer quantizers than the number of AI/ML model outputs. One or more quantizer(s) may apply to one or more output(s) of the AI/ML model. A set of quantizers may include a single quantizer applied to one or more (e.g., all) outputs of an AI/ML model at a given time.

Triggers may select sets of quantizers and/or selection criteria may be implemented, as described herein. As noted above, the WTRU may receive configuration information that indicates a plurality of CSI quantization settings and/or criteria for selecting from the plurality of CSI quantization settings, to align the quantizers at WTRU and/or gNB. As described herein, the WTRU may select one or more CSI quantization settings based on the criteria indicated in the configuration message.

A WTRU may consider a set of quantizers to be active if the WTRU may use the set to generate the payload of an UL transmission (e.g., as a feedback report). A WTRU may consider one set of quantizers as a fallback set of quantizers. The fallback set of quantizers may be active (e.g., always be active). A WTRU may select a quantizer set from the group of active sets of quantizers. The WTRU may make the selection of a set of quantizers for every feedback report instance. The selection may be valid for multiple feedback report instances. An event may trigger the selection of a set of quantizers.

A WTRU may trigger and/or (re)select a set of quantizers and/or may perform the selection of a set of quantizers based on several factors (e.g., based on the configuration message). For example, a WTRU may trigger and (re)select a set of quantizers and/or may perform the selection of a set of quantizers based on the performance of one or more set(s) of quantizers. A WTRU may test the performance of one or more set(s) of quantizers and/or may select the set(s) of quantizers that maximizes the performance. The performance may be determined based on a metric. The metric may include one or more of: quantization error (e.g., mean/average error, and/or largest/smallest error within the set of quantizers), compression rate, and/or minimum compression error (e.g., over-all error of the AI/ML model and/or set of quantizers). The metric may be determined per quantizer within the set of quantizers, averaged over all quantizers, per output of the AI/ML model, and/or averaged over one or more (e.g., all) outputs of the AI/ML model.

A WTRU may trigger and/or (re)select a set of quantizers and/or may perform the selection of a set of quantizers based on performance change with a previously used set of quantizers. For example, a WTRU may select a new set of quantizers if the performance of the new set of quantizers is above a threshold value and/or the performance of the previously used set of quantizers is below a threshold value. The WTRU may select a new set of quantizers if the performance of a new set of quantizers is stronger than the performance of the previously used set of quantizers (e.g., possibly plus an offset).

The performance of the sets of quantizers may be defined as described herein. The performance of a previous set of quantizers may be determined based on the performance achieved for a previous transmission and/or feedback report instance. The performance of a previous set of quantizers and/or a new set of quantizers may be determined based on the expected performance for an upcoming transmission and/or feedback report instance.

A WTRU may trigger and (re)select a set of quantizers and/or may perform the selection of a set of quantizers based on a measurement. The feedback report may include the measurement (e.g., an input of an AI/ML model). The measurement may include one or more of: RSRP, reference signal received quality (RSRQ), RSSI, CO, constant bit rate (CBR), SINR, CQI, RI, PMI, angle of arrival (AoA), angle of departure (AoD), doppler spread, delay spread, doppler shift, average delay, and/or WTRU speed. For example, a WTRU may select a first set of quantizers when experiencing a first set of channel characteristics and/or a second set of quantizers when experiencing a second set of channel characteristics.

A WTRU may trigger and/or (re)select a set of quantizers and/or may perform the selection of a set of quantizers based on the parameter of the transmission and/or feedback report. For example, a WTRU may select a set of quantizers based on the priority of a feedback report. The priority of the feedback report may be configurable and/or may be determined by the WTRU as a function of an associated transmission. In examples, a WTRU may determine a threshold and/or offset and/or performance metric to select a set of quantizers as a function of a parameter of the feedback report (e.g., priority).

A WTRU may trigger and/or (re)select a set of quantizers and/or may perform the selection of a set of quantizers based on if a transmission and/or feedback report collides with another transmission from the WTRU. For example, a WTRU may determine that the resources of a feedback report overlap with another transmission from the WTRU. The WTRU may trigger and/or select and/or may select a set of quantizers based on whether the overlapping leads to multiplexing of multiple transmissions and/or to dropping of lower priority transmissions.

A WTRU may trigger and/or (re)select a set of quantizers and/or may perform the selection of a set of quantizers based on a transmission power. For example, a WTRU may trigger and/or select a set of quantizers based on the transmit power, available transmit power, and/or power headroom.

A WTRU may trigger and/or (re)select a set of quantizers and/or may perform the selection of a set of quantizers based on the transmission resources. For example, a WTRU may trigger and/or select a set of quantizers based on the feedback report resource (e.g., or a parameter thereof) and/or feedback resource type (e.g., PUCCH format). In examples, the WTRU may select a set of quantizers as a function of the channel on which the transmission and/or feedback report occurs. For example, the WTRU may select a quantizer based on whether the feedback report is transmitted on a PUCCH and/or a simultaneous PUCCH/PUSCH and/or as UCI on PUSCH.

A WTRU may trigger and/or (re)select a set of quantizers and/or may perform the selection of a set of quantizers based on channel availability. For example, a WTRU may select a set of quantizers based on whether the WTRU may initiate a channel occupancy time (COT) and/or share a COT for the transmission. The WTRU may select a set of quantizers as a function of a listen-before-talk (LBT) procedure and/or based on parameters of an LBT procedure.

A WTRU may trigger and/or (re)select a set of quantizers and/or may perform the selection of a set of quantizers based on a survival time. For example, a WTRU may select a set of quantizers based on the remaining survival time, if survival time is expiring, and/or has expired.

A WTRU may trigger and/or (re)select a set of quantizers and/or may perform the selection of a set of quantizers based on an intended receiver. For example, a WTRU may select a set of quantizers based on the gNB, cell, and/or transmission and reception point (TRP).

A WTRU may trigger and/or (re)select a set of quantizers and/or may perform the selection of a set of quantizers based on performance of an associated transmission. For example, a WTRU may determine a set of quantizers based on the performance of an associated UL and/or DL transmission (e.g., a transmission of the same priority). For example, based on a HARQ-ACK and/or HARQ-NACK rate, the WTRU may select a set of quantizers.

A WTRU may trigger and/or (re)select a set of quantizers and/or may perform the selection of a set of quantizers based on an associated transmission and/or transmission type. For example, the parameter of an associated transmission may include one or more of: logical channel, data radio bearer (DRB), signal radio bearer (SRB), and/or function of the transmission (e.g., measurement reporting, and/or radio access (RA)).

A WTRU may trigger and/or (re)select a set of quantizers and/or may perform the selection of a set of quantizers based on the AI/ML encoder used. For example, a WTRU may select a set of quantizers based on the index, type, and/or a parameter of the AI/ML encoder used.

A WTRU may trigger and/or (re)select a set of quantizers and/or may perform the selection of a set of quantizers based on reception of an indication from the gNB. For example, a WTRU may use a set of quantizers. The WTRU may receive the configuration via quantizer set index. In examples, the WTRU may receive an indication to trigger quantizer set (re)selection. The WTRU may receive the indication via RRC and/or DCI and/or MAC CE transmission.

A WTRU may trigger and/or (re)select a set of quantizers and/or may perform the selection of a set of quantizers based on timing of a transmission. For example, a WTRU may trigger and/or select a set of quantizers based on the timing of the transmission of feedback report. The WTRU may select a set of quantizers at periodic time instances and/or a set of quantizers for every n feedback report instances.

A WTRU may trigger and/or (re)select a set of quantizers and/or may perform the selection of a set of quantizers based on a timer. The WTRU may (re) start a timer when the WTRU selects a set of quantizers, a new set of quantizers and/or may trigger and/or select a new set of quantizers when the timer elapses. The timer may be modelled as a number of time instances, slots, subframes, and/or symbols. The WTRU may count the time instances, slots, subframes, and/or symbols and/or may select a new set of quantizers when the counter reaches a configurable value. The WTRU may restart the counter when the WTRU selects a new set of quantizers. In examples, the rules for a WTRU to select a set of quantizers may also apply to rules for a WTRU triggered to select a set of quantizers.

A fallback set of quantizers may be implemented as described herein. In examples, the WTRU selection of a set of quantizers may fail. For example, a WTRU may be configured with a set of quantizers. However, that set of quantizers may not satisfy another criterion (e.g., a performance criterion). A WTRU may select and/or use a default and/or fallback set of quantizers if a selection fails. The fallback and/or default set of quantizers may be configured. The WTRU may determine the fallback and/or default set of quantizers. The WTRU may indicate the fallback and/or default set of quantizers to the gNB, to align the quantizers at WTRU and/or gNB. For example, a WTRU may override a gNB indication of a set of quantizers and/or the WTRU may report the use of the fallback and/or default set of quantizers, e.g., in a transmission using the fallback and/or default set of quantizers.

The WTRU may send feedback of the selected quantizer (e.g., in a feedback report) to the network, to align the quantizers at the WTRU and/or the gNB. For example, feedback of the selected quantizer may include a WTRU report of identify of set of quantizers. A WTRU may report the identify of a set of quantizers. The identity of a set of quantizers may include an index assigned to the set of quantizers; a parameter of the set of quantizers (e.g., number of quantizers in the set and/or association between quantizers and AI/ML output); and/or parameters of the quantizers in the set.

The WTRU may report the quantizer type (e.g., uniform and/or non-uniform), the quantization levels, the quantization scale, the number of quantization levels, etc. The identity of a set of quantizers may include an associated AI/ML model and/or a function using the set of quantizers. For example, the WTRU may report that a set of quantizers is to be used for CSI feedback reporting.

Different triggers may be implemented to report identity. A WTRU may trigger and/or report the identity of a set of quantizers by several different means. For example, the WTRU may use time as a trigger to report the identity of a set of quantizers. The WTRU may be configured with periodic instances when it may report the identity of a currently used and/or active set of quantizers. The WTRU may trigger and/or report the identity of a set of quantizers by the use of a set of quantizers. For example, a WTRU may report the identity of a used set of quantizers whenever the WTRU performs a transmission using the set of quantizers. The WTRU may include the identity of a set of quantizers used to generate a CSI feedback report, in one or more (e.g., every) CSI feedback report.

The WTRU may trigger and/or report the identity of a set of quantizers by a change or (re)selection of a set of quantizers. For example, when the WTRU triggers and/or (re)selects a set of quantizers, the WTRU may report the identity of the newly selected set of quantizers. The report may be independent and/or may be multiplexed in a transmission (e.g., first transmission) using the selected set of quantizers. The WTRU may report the identity of a set of quantizers whenever a selection is performed and/or when (e.g., only when) the newly selected set of quantizers differs from the previously used and/or indicated set of quantizers. The WTRU may trigger and/or report the identity of a set of quantizers by reception of a report trigger. For example, the WTRU may receive a trigger to report a currently used set of quantizers. The trigger may be received in DCI and/or MAC CE.

A WTRU may report the feedback of the selected quantizer using reporting resources. The WTRU may report the identity of a set of quantizers using one or more reporting resources. For example, a WTRU may report the identity of a set of quantizers using PUCCH, (e.g., a PUCCH resource assigned for such reporting). In examples, the WTRU may multiplex the identity of the set of quantizers in a PUCCH resource used to transmit UCI, SR, and/or HARQ-ACK. The WTRU may report the identity of a set of quantizers using PSCCH. The WTRU may report the identity of a set of quantizers using PUSCH (e.g., in UCI on PUSCH); MAC CE; and/or RRC.

Reception of new set of quantizers may be acknowledged, as described herein. When a WTRU is indicated a set of quantizers (e.g., by the gNB), the WTRU may acknowledge reception of the indication and/or change to the indicated set of quantizers, to align the quantizers at the WTRU and/or the gNB. The acknowledgement may be transmitted via similar (e.g., the same) means as the means described herein for the report of the identity of a set of quantizers.

The WTRU may report of performance of a set of quantizers, as described herein. A WTRU may report the performance of one or more set(s) of quantizers. The WTRU may trigger and/or report the performance by the same triggers and/or reporting resources as the triggers and/or reporting resources as described herein for the reporting of the identity of a set of quantizers.

A WTRU may receive of an indication of a set of quantizers used by another node, as described herein. The WTRU may receive an indication from another node that the other node used a set of quantizers for transmission to the WTRU (e.g., from the gNB for DL transmissions and/or from another WTRU for SL transmissions). Based on the indicated set of quantizers used by the other node, the WTRU may perform several tasks. For example, based on the indicated set of quantizers used by the other node, the WTRU may select a set of de-quantizers associated with the indicated set of quantizers. Based on the indicated set of quantizers used by the other node, the WTRU may train and/or retrain a set of de-quantizers and/or AIML model; transmit an acknowledgement that the WTRU has received the indication of the set of quantizers; and/or transmit an indication of the identity of the selected set of de-quantizers.

The identity of a set of de-quantizers may be defined similarly to the identity of a set of quantizers. Based on the indicated set of quantizers used by the other node, the WTRU may select a new set of quantizers (e.g., for transmissions from the WTRU to the other node) that is associated with the indicated set of quantizers. Based on the indicated set of quantizers used by the other node, the WTRU may report a performance metric. The performance metric may relate to the reception of a transmission using the new set of quantizers and/or related to one or more set(s) of de-quantizers and/or related to the AI/ML model.

The WTRU may request for another node to change set of quantizers. A WTRU may report a request for another node to change the other node's selected set of quantizers. The request may indicate (e.g., include) a preferred set of quantizers and/or a cause for the request. The cause for the request may include one or more of: performance metric satisfying a condition, change in AI/ML model at the WTRU, and/or (re) training of de-quantizer and/or AI/ML model at the WTRU. The request for another node to change the other node's selected set of quantizers may be transmitted via similar means as the indication of identity of selected quantizer set as described herein. The request for another node to change the other node's selects set of quantizers may be transmitted via HARQ-ACK reporting. For example, if the HARQ-ACK rate is below a threshold value, the WTRU may include a request to change a selected set of quantizers.

CSI quantization may be implemented with non-aligned quantizers. One or more types of quantizers may be implemented, wherein the quantizer type and/or method to build the quantizer may include: uniform quantizer, non-uniform quantizer, distribution-based quantizer, and/or clustering-based quantizer. One or more quantization parameters may be used to determine properties of a quantizer. The properties of a quantizer may include: quantization granularity, quantization overhead, quantization error, quantization range, quantization dynamic range, quantization complexity, quantization amplitude granularity, quantization phase granularity, and/or quantization accuracy, etc.

The quantization parameter may include one or more of number of bits, amplitude range, phase range, number of bits for amplitude, number of bits for phase, and/or quantization gap.

A quantizer may be characterized based on quantization type and/or one or more quantization parameters configured, determined, and/or used. A quantizer and a de-quantizer may be interchangeably used. For example, a quantizer at the transmitter may be a quantizer, for example, which changes a value (e.g., integer and/or complex value) to a set of bits. In examples, a quantizer at the receiver may be a de-quantizer, for example, which changes a set of bits to a value (e.g., integer and/or complex value).

A quantizer at the WTRU may be interchangeably used with a quantizer at encoder part of the autoencoder (AE) in AI/ML and/or a quantizer at the gNB may be interchangeably used with a quantizer at decoder part of the AE in AI/ML.

For a two-sided model (e.g., AE), a WTRU-side model may be an encoder part of the AE and/or a gNB-side model may be decoder part of the AE.

Independent quantizer determination may be performed at the WTRU and/or gNB. A first quantizer may be determined for a WTRU-side model and/or a second quantizer may be determined for a gNB-side model, wherein the first and/or second quantizer may be determined based on a number of factors as described herein. In other words, a WTRU may determine a quantizer for the output of the encoder (e.g., output of WTRU-side model), wherein the WTRU may determine the quantizer (e.g., quantizer type and associated parameters) based on a number of factors as described herein.

In examples, a WTRU may determine a quantizer for the output of the encoder based on a distribution of input and/or output data of the WTRU-side model. The data may be a dataset used for training, test, and/or inference. The WTRU may determine a quantizer for the output of the encoder based on uplink resource configured, determined, and/or indicated for the reporting (e.g., reporting of the output of the WTRU-side model). The uplink resource may include PUSCH, PUCCH, PRACH, and/or SRS resources. The WTRU may determine a quantizer for the output of the encoder based on the number of available bits for reporting of the output data of the WTRU-side model. The number of available bits may be uncoded bit before the channel encoder and/or total number of bits to be reported. The WTRU may determine a quantizer for the output of the encoder based on the WTRU type (e.g., WTRU category, etc.); the AI/ML model used (e.g., model-ID); and/or the number of antenna ports (e.g., number of CSI-RS ports) associated with the CSI reporting.

A gNB may determine a quantizer for the input of the decoder (e.g., input of gNB-side model). The gNB may determine quantizer (e.g., quantizer type and/or associated parameters) based on one or more factors: e.g., a gNB may determine a quantizer for the input of the decoder based on distribution of input and/or output data of the WTRU-side model, wherein the data may be a dataset used for training, test, and/or inference. The gNB may determine a quantizer for the input of the decoder based on the AI/ML model used (e.g., model-ID) at the WTRU-side model (e.g., or both WTRU-side model and/or gNB-side model).

Quantizer set association may be implemented with a gNB side model. For example, when the two-sided model is used, one or more quantizers may be used for a first side model (e.g., WTRU) and/or a second side model (e.g., gNB). A subset of quantizers in a first side model may be determined based on one or more factors: e.g., a subset of quantizers in a first side model may be determined based on AI/ML model at the second side model. For example, a WTRU may determine a subset of quantizers based on the information of the gNB-side model when two-sided model is used. The information of the gNB-side model may include one or more of: identification of the model (e.g., model-ID) and/or functionality of the model (e.g., CSI compression in frequency domain, CSI compression in time/frequency domain, and/or CSI compression in time/frequency/spatial domain).

A subset of quantizers in a first side model may be determined based on quantizer type and/or parameters used at the second side model. In examples, quantizers with uniform quantization may be considered as a candidate quantizer for the first side model, for example, if uniform quantizer is used at the second side model. Quantizers with the non-uniform quantizer type may be considered as candidate quantizers at the first side model if the non-uniform quantizer (e.g., distribution based, clustering based) is used at the second side model. The first side model may be at WTRU and/or at gNB and/or the second side model may be at the gNB and/or at WTRU.

A WTRU and/or gNB may determine a quantizer within the determined subset of quantizers to perform reporting output of the first side model (e.g., encoder) in the two-sided model. The WTRU and/or gNB may determine a quantizer within the determined subset of quantizers to perform determining first side model and/or second side model associated with the determined quantizer (e.g., when a quantizer is part of the AI/ML model). The WTRU and/or gNB may determine a quantizer within the determined subset of quantizers to perform reconstructing compressed data with a second side model and/or fine-tuning of the AI/ML model with addition dataset collected.

Information on the determined quantizer may be signaled to the node where the other side of the AE resides (e.g., gNB and/or UE), wherein quantizer information may be one or more of the following. For example, the quantizer information may include a quantizer identity. One or more quantizers may be used and each quantizer may be indexed with an identifier. For example, the quantizer information may include characteristics of the quantizer. The characteristics of the quantizer may be associated with the quantizer identity of method to build the quantizer. The characteristics of the quantizer may be associated with the quantizer identity of quantizer parameters. The characteristics of the quantizer may be associated with the quantizer identity of quantizer overhead and/or bitwidth.

In examples, a subset of quantizers at a first side model (e.g., WTRU) may be determined based on quantizer characteristics indicated from a second side model (e.g., gNB). For example, gNB may indicate and/or configure to a WTRU a set of quantizer characteristics to be used at the WTRU side model. In examples, the WTRU may determine a quantizer which satisfies the set of quantizer characteristics indicated and/or configured by the gNB.

The quantizer characteristics may include a method to build a quantizer (e.g., uniform, distribution-based, and/or clustering-based). In examples, the quantizer characteristics may include quantizer parameters (e.g., range, granularity of amplitude, granularity of phase, and/or quantization bits, etc.); use case (e.g., CSI compression, CSI prediction, and/or beam prediction, etc.); channel condition (e.g., high Doppler and/or low Doppler, etc.); and/or deployment scenario (e.g., Umi, Uma, and/or InH, etc.)

The quantizer determined at the WTRU side may be unknown and/or reported to the gNB. A subset of quantizers for a first side model and/or a second side model may be implicitly determined based on a number of factors. For example, a subset of quantizers for a first side model and/or a second side model may be implicitly determined based on training conditions for the AI/ML models. The training condition may include at least one of the following factors: a training dataset size, a training latency, a training type of two-sided model (e.g., Type1: joint training; Type2: joint training via air interface; and/or Type3: separate training). The subset of quantizers for a first side model and/or a second side model may be implicitly determined based on a use case (e.g., CSI compression, CSI prediction, and/or beam prediction, etc.); channel condition (e.g., high Doppler and/or low Doppler, etc.); and/or deployment scenario (e.g., Umi, Uma, and/or InH, etc.).

Exemplary systems and/or methods for the distribution-based adaptive CSI Quantization are described herein. For example, the WTRU may receive configuration on the adaptive (e.g., primary) quantizer, for example to align the quantizers at the WTRU and the gNB. The gNB may configure the WTRU to include the type of method to build the quantizer (e.g., distribution-based and/or Gaussian). The gNB may configure the WTRU to include the number of quantizers that includes multiple quantizers. The gNB may configure the WTRU to include the quantization performance metric that includes QN. The gNB may configure the WTRU to include the secondary quantizer. The secondary quantizer may be uniform. The gNB may configure the WTRU to include the feedback type that may be quantization parameters in MAC CE.

The WTRU may use the secondary quantizer during the process(es) to determine parameters and/or build the adaptive (e.g., primary) quantizer. During the process(es), a secondary quantizer may be used to quantize the CSI compression.

The WTRU may determine the parameters of the adaptive (e.g., primary) quantizer and/or may adapt the quantization blocks. To determine the parameters of the quantizer and/or adapt the quantization blocks, the WTRU may perform as described herein. For example, the WTRU may collect samples of the encoder output values separately that will be used to build one quantizer per output. The WTRU may compute the mean and/or variance of the samples for each encoder output. The WTRU may adapt the CDF transform of the non-uniform quantizer block for each output based on the computed parameters of the distributions. The WTRU may then determine the resolution (e.g., or number of steps) of the uniform quantizer in the non-uniform quantizer block. A 64-step uniform quantizer may be built to obtain 6 bits resolution, for example, assuming that the number of encoder outputs is 10 and/or the UCI size is 60 bits.

The WTRU may feedback the parameters of the distribution to the gNB. The parameters may include two scalar values for the mean and/or variance of the distribution per each output (e.g., two 32-bits long values for each of the 10 encoder outputs). The WTRU may transmit the feedback on quantization parameters semi-statically in a UL MAC CE. The WTRU may send feedback to the gNB for the gNB to build the de-quantizer.

The WTRU and/or gNB may start using the distribution-based primary quantizer. In examples, the WTRU may receive indication from the gNB to switch to the distribution-based quantizer. The WTRU may switch to the distribution-based primary quantizer, for example, after the indication. Each output of the encoder may be quantized using the distribution-based quantizer.

The WTRU may monitor the performance of the distribution-based primary quantizer at each compressed CSI. The WTRU may compute the quantization noise of the distribution-based primary quantizer and/or the secondary quantizer, for example, at each compressed CSI transmission. The WTRU may use the distribution-based quantizer, for example, if the QN of the distribution-based quantizer is lower than the secondary quantizer. Otherwise, the WTRU may use the secondary quantizer. The WTU may feedback whether the distribution-based and/or secondary quantizer is used (e.g., using a single bit) together with the compressed CSI in the UCI field.

The WTRU may report the performance of the distribution-based quantizer to gNB. The WTRU may report the quantizer performance metric to the gNB, for example, periodically (e.g., every N slots). The WTRU may receive an indication to update the quantizer parameters if the quantizer performance is below a certain threshold.

Notable systems and/or methods for the cluster-based adaptive CSI quantization are described herein. For example, the WTRU may receive a configuration on the adaptive (e.g., primary) quantizer. The gNB may configure the WTRU to include the type of method to build quantizer that includes a cluster-based configuration; the number of quantizers that includes a single quantizer; the quantization performance metric that includes NMSE; and/or the secondary quantizer. The secondary quantizer may be uniform. The gNB may configure the WTRU to include the feedback type. The feedback type may include quantization parameters in MAC CE.

The WTRU may use the secondary quantizer during the process to determine parameters and/or build the adaptive (e.g., primary) quantizer. During this process, the secondary quantizer may be used to quantize the CSI compression.

The WTRU may compute the centroids of the clusters and/or adapt the quantization blocks. The WTRU may collect combined samples of the encoder output values. The WTRU may determine the number clusters based on the UCI overhead and/or the number of encoder outputs. Assuming the UCI overhead is 60 bits and/or the number of encoder outputs is 10, then the number of clusters may be 64 where each cluster is identified by 6 bits. The WTRU may partition the historical samples into 64 clusters and/or computes the centroids using, e.g., the k-means method. The WTRU may adapt the quantizer with the computed centroids.

The WTRU may feedback the centroids of the cluster to gNB. The centroids may be scalar values, for example, represented with 32-bits for each of the 64 clusters. The WTRU may transmit the feedback on quantization parameters semi-statically in a UL MAC CE. The WTRU may send feedback to the gNB for the gNB to build the de-quantizer.

The WTRU and/or gNB may start using the cluster-based primary quantizer. The WTRU may be receiving indication from the gNB to switch to the cluster-based quantizer. The WTRU may switch to the cluster-based quantizer after the indication. Each output value of the encoder may be represented with the cluster index that has the closest centroid to the encoder output value.

The WTRU may monitor the performance of the cluster-based quantizer, for example, at each compressed CSI. The WTRU may compute the NMSE of the cluster-based quantizer and/or the secondary quantizer at each compressed CSI transmission. The WTRU may use the cluster-based quantizer if the NMSE of the cluster-based quantizer is lower than the secondary quantizer. Otherwise, the WTRU may use the secondary quantizer. The WTRU may feedback whether the cluster-based and/or secondary quantizer is used (e.g., using a single bit) together with the compressed CSI in the UCI field.

The WTRU may report the performance of the cluster-based quantizer to the gNB. In examples, the WTRU may report the quantizer performance metric to the gNB periodically (e.g., every N slots). The WTRU may receive an indication to update the quantizer parameters if the quantizer performance is below a certain threshold.

Although features and/or elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1-20. (canceled)

21. A wireless transmit/receive unit (WTRU) comprising:
a processor and a memory, the processor configured to:
receive configuration information from a network node for an alignment of one or more compressed channel state information (CSI) quantizers at the WTRU and at the network node, the configuration information indicating a plurality of CSI quantization settings and criteria to select a CSI quantization setting from the plurality of CSI quantization settings;
perform one or more CSI measurements on one or more reference signals;
encode the one or more CSI measurements using an auto-encoder;
select a CSI quantization setting of the plurality of quantization settings based on the criteria indicated in the configuration information;
quantize the encoded one or more CSI measurements using a quantizer, wherein the encoded one or more CSI measurements are quantized based on the selected CSI quantization setting; and
send a feedback report to the network node for the alignment of the one or more compressed CSI quantizers, wherein the feedback report comprises the quantized one or more CSI measurements and an indication of the selected CSI quantization setting.

22. The WTRU of claim 21, wherein the criteria are based on one or more of a reference signal received power (RSRP) measurement, a CSI measurement, a type of the feedback report, resources used for sending the feedback report, or a metric associated with the encoded one or more CSI measurements.

23. The WTRU of claim 21, wherein the indication of the selected CSI quantization setting comprises an index of a codebook associated with the plurality of CSI quantization settings.

24. The WTRU of claim 21, wherein the indication of the selected CSI quantization setting comprises and indication of one or more of a quantization type, a quantization parameter, a quantizer granularity, or a resolution of the quantizer.

25. The WTRU of claim 24, wherein the resolution of the quantizer is based on uplink control information (UCI) feedback and a number of encoder outputs.

26. The WTRU of claim 21, wherein the quantizer is configured separately from the auto-encoder.

27. The WTRU of claim 21, wherein the criteria comprise of one or more performance metrics, wherein the metrics comprise at least one of quantization noise or normalized mean square error (NMSE).

28. The WTRU of claim 21, wherein the processor is further configured to:
select the number of CSI quantizers, wherein the type of a selected CSI quantizer is uniform, distribution based, or clustering based.

29. The WTRU of claim 28, wherein the WTRU is configured to select the distribution based type when the WTRU computes the distribution of one or more encoder output values using historical samples.

30. The WTRU of claim 28, wherein the WTRU is configured to select the clustering based type when the WTRU computes centroids for one or more encoder output values using historical samples.

31. A method implemented by a wireless transmit/receive unit (WTRU), the method comprising:
receiving configuration information from a network node for an alignment of one or more compressed channel state information (CSI) quantizers at the WTRU and at the network node, the configuration information indicating a plurality of CSI quantization settings and criteria to select a CSI quantization setting from the plurality of CSI quantization settings;
performing one or more CSI measurements on one or more reference signals;
encoding the one or more CSI measurements using an auto-encoder;
selecting a CSI quantization setting of the plurality of quantization settings based on the criteria indicated in the configuration information;
quantizing the encoded one or more CSI measurements using a quantizer, wherein the encoded one or more CSI measurements are quantized based on the selected CSI quantization setting; and
sending a feedback report to the network node for the alignment of the one or more compressed CSI quantizers, wherein the feedback report comprises the quantized one or more CSI measurements and an indication of the selected CSI quantization setting.

32. The method of claim 31, wherein the criteria are based on one or more of a reference signal received power (RSRP) measurement, a CSI measurement, a type of the feedback report, resources used for sending the feedback report, or a metric associated with the encoded one or more CSI measurements.

33. The method of claim 31, wherein the indication of the selected CSI quantization setting comprises an index of a codebook associated with the plurality of CSI quantization settings.

34. The method of claim 31, wherein the indication of the selected CSI quantization setting comprises and indication of one or more of a quantization type, a quantization parameter, a quantizer granularity, or a resolution of the quantizer.

35. The method of claim 34, wherein the resolution of the quantizer is based on uplink control information (UCI) feedback and a number of encoder outputs.

36. The method of claim 31, wherein the quantizer is configured separately from the auto-encoder.

37. The method of claim 31, wherein the criteria comprise of one or more performance metrics, wherein the metrics comprise at least one of quantization noise or normalized mean square error (NMSE).

38. The method of claim 31, further comprising:
selecting the number of CSI quantizers, wherein the type of a selected CSI quantizer is uniform, distribution based, or clustering based.

39. The method of claim 38, wherein the WTRU is configured to select the distribution based type when the WTRU computes the distribution of one or more encoder output values using historical samples.

40. The method of claim 38, wherein the WTRU is configured to select the clustering based type when the WTRU computes centroids for one or more encoder output values using historical samples.
